(19) United States
(12) Patent Application Publication
(10) Pub. No.: US 2024/0294769 A1
(43) Pub. Date: Sep. 5, 2024

(54) RADIATION CURABLE COATING COMPOSITION AND SUBSTRATES COATED WITH SAID COATING COMPOSITION

(71) Applicant: BASF COATINGS GMBH, Muenster (DE)

(72) Inventors: Andreas DOPP, Muenster (DE); Nicole Kathleen SWART, Muenster (DE); Katharina FECHTNER, Muenster (DE)

(21) Appl. No.: 18/560,308

(22) PCT Filed: Jun. 2, 2022
(86) PCT No.: PCT/EP22/65053

§ 371 Date: Nov. 10, 2023

(30) Foreign Application Priority Data
Jun. 9, 2021 (EP) 21178529.0

(51) Int. Cl. C09D 4/06; C08F 265/06; C08F 290/06; C08G 18/67; C08G 18/81; C09D 5/00; C09D 151/00; C09D 151/08

(52) U.S. Cl. CPC C09D 4/06; C08F 265/06; C08F 290/067; C08G 18/672; C08G 18/8175; C09D 5/002; C09D 151/003; C09D 151/08

(57) ABSTRACT

Disclosed herein are radiation curable coating compositions including a mixture of crosslinkable polymers or oligomers in combination with at least one hydrophobic unsaturated monomer and at least 20 wt. % of hydrophilic unsaturated monomers. The coating of various substrates, in particular plastic substrates, with these coating compositions results in significantly improved surface roughness without the formation of undesired film defects. The coating compositions can be overcoated with commonly known coating compositions to produce multilayer coatings having an improved adhesion, especially wet adhesion, and a high optical quality. Further disclosed herein are a method for forming a coating onto an object and a coated object prepared according to the method. Additionally disclosed herein is a method of using the radiation curable coating composition to improve the surface roughness of plastic substrates, in particular plastic substrates produced by additive manufacturing.

The present invention relates to radiation curable coating compositions comprising a mixture of crosslinkable polymers or oligomers in combination with at least one hydrophobic unsaturated monomer and at least 20 wt. % of hydrophilic unsaturated monomers. Coating of various substrates, in particular plastic substrates, with these coating compositions results in significantly improved surface roughness without the formation of undesired film defects. The coating compositions can be overcoated with commonly known coating compositions to produce multilayer coatings having an improved adhesion, especially wet adhesion, and a high optical quality. The present invention moreover relates to a method for forming a coating onto an object and a coated object prepared according to the inventive method. Finally, the present invention relates to the use of an inventive radiation curable coating composition to improve the surface roughness of plastic substrates, in particular plastic substrates produced by additive manufacturing.

### STATE OF THE ART

Component parts, such as metal and plastic component parts, can be manufactured by traditional manufacturing processes, for example by rolling followed by stamping, bending, or deep-drawing or by molding processes.

Recently, component parts are increasingly produced by additive manufacturing (AM). Additive manufacturing (AM) refers to processes used to create a three-dimensional object under computer control by forming layers of material and encompasses 3D Printing, Rapid Prototyping (RP), Direct Digital Manufacturing (DDM), layered manufacturing and additive fabrication. Objects can be of almost any shape or geometry and are produced using digital model data from a 3D model or another electronic data source such as a STL file. Thus, unlike material removed from a stock in the conventional machining process, 3D printing or AM builds a three-dimensional object from computer-aided design (CAD) model or an AMF file by successively adding material in a layer by layer process. Additive manufacturing opens up many new options and design benefits when compared to traditional manufacturing techniques. The design-for-function, as opposed to design-for-manufacture, philosophy presents a fundamental paradigm shift, allowing for increased part complexity tailored to particular design's requirements. It also allows for ease of customization, as a design for additive manufacturing need not adhere to the traditional end goal of mass production in order to be financially and practically viable. Moreover, components parts can be produced in a single manufacturing step and often at low cost.

However, the component parts produced by traditional manufacturing processes and especially the surface of AM materials typically have a surface roughness that is significantly greater than the roughness required for use of the component parts to assemble finished product. Therefore, the surface of the produced component parts need to be treated with commonly known surface treatment processes to improve or modify appearance, geometry, adhesion or wettability, solderability, corrosion resistance, tarnish resistance, chemical resistance, wear resistance, hardness, electrical conductivity, burrs and other surface flaws, and the surface friction. Surface treatment can be performed using various processes, such as surface finishing or coating of the surface.

Surface finishing, also known as micromachining, microfinishing, and short-stroke honing, relates to a broad range of industrial processes that alter the surface of a manufactured item to improve the surface roughness. Well known mechanical surface finishing processes include, e.g., abrasive blasting, sandblasting, burnishing, grinding, mass finishing processes, tumble finishing, vibratory finishing, polishing, buffing, or lapping.

Coating of the surface is usually performed by applying a coating composition to the surface of the substrate and curing said applied coating composition. Depending on the components being present in the coating composition, the cured coating film formed on the surface serves as a protective layer, improves the adhesion of further coating layers to the component part and/or results in a specific visual impression. Such coating compositions are often called primer coating compositions.

The use of such primer coating compositions is well known in the state of the art. However, there still remains a need to provide low temperature curing primer compositions which significantly reduce the surface roughness of the produced component part while at the same time improving the adhesion of further coating layers without negatively influencing the overall visual impression of the multilayer coating.

### Object

Accordingly, an object of the present invention is to provide radiation curable coating compositions which can be cured at low temperatures, and which have a high levelling in order to ensure sufficient coverage of the surface. The coating layer formed from the radiation curable coating composition should significantly reduce the surface roughness of the component parts, in particular plastic AM materials, at comparably low film thicknesses while improving the adhesion of further coating layers being present on the coating layer formed from the radiation curable coating composition. The occurrence of film defects, such as blisters or craters, after curing of the coating compositions should be avoided to provide coating layers having a high optical quality. The opacity of the coating layers resulting from the radiation curable coating compositions should be customizable according to the specific needs without a negative impact on the adhesion and the overall visual impression of cured coating layers or multilayer coatings comprising said cured coating layers. Moreover, the formed coating layer should be easily overcoatable with commonly known coating materials without extensive surface preparation, such as sanding or polishing.

### Technical Solution

The objects described above are achieved by the subject matter claimed in the claims and also by the preferred embodiments of that subject matter that are described in the description hereinafter.

A first subject of the present invention is therefore a radiation curable coating composition comprising-based on the total weight of the coating composition—
a) at least one unsaturated urethane (meth)acrylate oligomer or polymer (A),
b) at least one unsaturated acid-functional acrylic (meth)acrylate oligomer or polymer (B)
c) at least one ethylenically unsaturated monomer (C) having a calculated Hansen solubility parameter δₚ of less than 5 MPa^{1/2},
d) more than 20 wt. % of at least one ethylenically unsaturated monomer (D) having a calculated Hansen solubility parameter δₚ of at least 5 MPa^{1/2}, and
e) optionally at least one photoinitiator (E),
wherein the solubility parameter δₚ is calculated according to the method described in “Pencil and Paper Estimation of Hansen Solubility Parameters” by Didier Mathieu, ACS Omega, 2018, 3, pages 17049 to 17056.

The above-specified method is hereinafter also referred to as coating composition of the invention and accordingly is a subject of the present invention. Preferred embodiments of the coating composition of the invention are apparent from the description hereinafter and also from the dependent claims.

In light of the prior art it was surprising and unforeseeable for the skilled worker that the objects on which the invention is based could be achieved by using an acid-functional acrylic (meth)acrylate oligomer or polymer in combination with a hydrophobic monomer (component (C)) and at least 20 wt.-% of at least one hydrophilic monomer (component (D)). The use of this combination results in coating layers which significantly reduce the surface roughness of substrates, in particular of plastic substrates having been produced by additive manufacturing (AM), thus rendering the polishing of the surface after production superfluous. The coating composition can be applied in various film thickness, ranging from rather thin film thickness of 20 μm to higher film thicknesses of up to 100 μm without the formation of undesired film defects, such as blisters or craters. Moreover, the coating layer formed from the radiation curable composition can be easily overcoated with further coating layers without further process steps, such as sanding, resulting in a high-quality overall visual impression of the multilayer and improved adhesion, in particular wet adhesion, of the multilayer coating to the substrate as well as improved interlayer adhesion between the coating layer formed from the radiation curable composition and additional coating layers. Additionally, the visual impression of the radiation curable coating composition can be customized by addition of pigments, matting agents, etc., without the occurrence of film defects or a negative influence on the adhesion to the substrate.

A further subject of the present invention is a method for forming a coating onto an object to be coated, said method comprising
(i) applying a radiation curable coating composition according to the invention to at least part of a surface of the object to be coated,
(ii) forming a coating film from the coating composition applied in step (i), and
(iii) curing the coating film formed in step (ii).

A further subject of the present invention is a coated object obtained by the inventive method.

Yet a further subject of the present invention is the use of a radiation curable coating composition of the invention to improve the surface roughness of plastic substrates, in particular plastic substrates produced by additive manufacturing.

### DETAILED DESCRIPTION

### Definitions:

First of all, a number of terms used in the context of the present invention will be explained.

The term “(meth)acrylate” shall refer hereinafter both to acrylate and to methacrylate, the term “poly(meth)acrylate” shall refer hereinafter both to polyacrylates and to polymethacrylates. Poly(meth)acrylates may therefore be constructed of acrylates and/or methacrylates and may contain further ethylenically unsaturated monomers such as, for example, styrene or acrylic acid. The term “acryloyl” and, respectively, “(meth)acryloyl” in the sense of the present invention embraces methacryloyl compounds, acryloyl compounds and mixtures thereof.

“Urethane (meth)acrylate oligomer or polymer” may refer to a (meth)acrylate oligomer or polymer comprising urethane, in particular polyurethane, segments.

The term “oligomer” refers to relatively low molecular weight compounds consisting of few, typically less than 10, monomer units. The monomer units may be structurally identical or similar, or they can be different from each other. Oligomeric compounds are typically liquid at room temperature and ambient pressure whereby the dynamic viscosity is preferably less than 500 Pa*s and more preferably less than 200 Pa*s at 23° C. measured according to DIN EN ISO 2555:2018-09 (Brookfield method). Oligomeric compounds typically have a Mₙ greater than 1,000 g per mole and preferably of 1,000 to 12,000 g per mole, as determined with GPC in THF using polystyrene standard calibration. In contrast, the term “polymer” refers to higher molecular weight compounds consisting of more monomer units than the oligomeric compounds and thus having a higher Mₙ.

“Unsaturated acid-functional acrylic (meth)acrylate oligomer or polymer” refers to unsaturated acrylic (meth)acrylate oligomers or polymers which comprise at least one acid group. The acid group can be neutralized with a suitable neutralizing agent, such as a base.

“Drying” of an applied coating composition refers to the evaporation of solvents from the applied coating composition. Drying can be performed at ambient temperature or by use of elevated temperatures. However, the drying does not result in a coating film being ready for use, i.e. a cured coating film as described below, because the coating film is still soft or tacky after drying. Accordingly, “curing” of a coating film refers to the conversion of such a film into the ready-to-use state, i.e. into a state in which the substrate provided with the respective coating film can be transported, stored and used as intended. More particularly, a cured coating film is no longer soft or tacky, but has been conditioned as a solid coating film which does not undergo any further significant change in its properties, such as hardness or adhesion to the substrate, even under further exposure to curing conditions.

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question.

### Inventive Radiation Curable Coating Composition:

### Urethane (Meth)Acrylate Oligomer or Polymer (A):

The inventive coating composition comprises as first mandatory component (A) at least one unsaturated urethane (meth)acrylate oligomer or polymer.

Urethane (meth)acrylates oligomers or polymers typically are obtained from the reaction of at least one polyisocyanate (A1), at least one polymerizable ethylenically unsaturated compound (A2) containing at least one reactive group capable to react with isocyanate groups, and optionally at least one other compound (A3) that contains at least one reactive group capable to react with isocyanate groups. By “other” is meant that compounds (A3) are different from compounds (A2). The “reactive groups capable to react with isocyanate groups” can be hydroxyl groups, amino groups and/or thiol groups. Most typically however they are hydroxyl groups.

Polyisocyanates (A1) contain at least two isocyanate groups. Typically the polyisocyanate contains not more than six isocyanate groups, more preferably not more than three isocyanate groups. Most typically it is a diisocyanate. The polyisocyanate is generally selected from aliphatic, cycloaliphatic, aromatic and/or heterocyclic polyisocyanates, or combinations thereof. Examples of aliphatic and cycloaliphatic polyisocyanates that may be used are: 1,6-diisocyanatohexane (HDI), 1,1′-methylene bis[4-isocyanatocyclohexane] (H12MDI), 5-isocyanato-1-isocyanatomethyl-1,3,3-trimethylcyclohexane (isophorone diisocyanate, IPDI). Aliphatic polyisocyanates containing more than two isocyanate groups are for example the derivatives of above mentioned diisocyanates like 1,6-diisocyanatohexane biuret and trimer. Examples of aromatic polyisocyanates that may be used are 1,4-diisocyanatobenzene (BDI), 2,4-diisocyanatotoluene (TDI), 1,1′-methylenebis[4-isocyanatobenzene] (MDI), xylylene diisocyanate (XDI), tetramethylxylylene diisocyanate (TMXDI), 1,5-naphtalene diisocyanate (NDI), tolidine diisocyanate (TODI) and p-phenylene diisocyanate (PPDI). The amount of polyisocyanate compound (A1) used for the synthesis of the urethane (meth)acrylate oligomer or polymer is generally in the range of from 10 to 70 wt. %, preferably from 15 to 60 wt. % and more preferably from 20 to 50 wt. % relative to the total weight of compounds used to prepare the urethane (meth)acrylate oligomer or polymer.

Compounds (A2) typically are (meth)acrylated compounds. Most often they are (meth)acrylated compounds containing essentially one reactive group capable to react with isocyanate groups. Such compounds typically comprise at least one unsaturated function such as acrylic or methacrylic groups and one nucleophilic function capable of reacting with isocyanate. This can be a hydroxyl, amino and/or thiol group, but typically is a hydroxyl group. Typically compounds (A2) are hydroxyl functional (meth)acrylates and in particular (meth)acryloyl mono-hydroxy compounds, or compounds comprising one hydroxyl group and one or more (meth)acryloyl groups. Suitable are for instance the esterification products of aliphatic and/or aromatic polyols with (meth)acrylic acid having a residual average hydroxyl functionality of about 1. Examples of suitable hydroxyl functional (meth)acrylates include but are not limited to hydroxyethyl (meth)acrylate, hydroxypropyl (meth)acrylate, hydroxybutyl (meth)acrylate, polyethyleneoxide mono(meth)acrylate, polypropyleneoxide mono(meth)acrylate, or any of those hydroxylated monomers further reacted with lactones or lactides which add to these hydroxyls in a ring-opening reaction.

Suitable are also the esterification products of aliphatic and/or aromatic polyols with (meth)acrylic acid having a residual average hydroxyl functionality of about 1 or higher. The partial esterification products of (meth)acrylic acid with tri-, tetra-, penta- or hexahydric polyols or mixtures thereof are preferred but it is also possible to use reaction products of such polyols with ethylene oxide and/or propylene oxide or mixtures thereof, or the reaction products of such polyols with lactones or lactides which add to these polyols in a ring-opening reaction until the desired residual hydroxyl functionality is reached. It is known to those skilled in the art that the (meth)acrylation of polyols proceeds to a mixture of (meth)acrylate components and that an easy and suitable way to characterize the mixture is by measuring its hydroxyl value (mg KOH/g).

Further Suitable compounds (A2) are the (meth)acrylic esters of linear and branched polyols in which at least one hydroxy functionality remains free. Particularly preferred are compounds comprising at least two (meth)acryl functions such as glycerol diacrylate, trimethylolpropane diacrylate, pentaerythritol triacrylate, ditrimethylolpropane triacrylate, dipentaerythritol pentaacrylate and their (poly)ethoxylated and/or (poly)propoxylated equivalents. Particularly preferred are pentaerythritol triacrylate (PETIA) and a dipentaerythrytol hydroxypentaacrylate (DPHA), a mixture containing essentially dipentaerythritol tetraacrylate, dipentaerythritol pentaacrylate and dipentaerythritol hexaacrylate.

Also suitable are C₁₋₄hydroxyalkyl(meth)acrylate-((poly)lactone)ₜ compounds, wherein t is an integer of from 1 to 10, preferably from 1 to 5. Preferably the (poly)lactone is a (poly)caprolactone. Examples of useful compounds in this category are Tone M100 (Dow Chemicals) and/or Bisomer PEMCURE 12A (Cognis). Other examples of suitable compounds (ii) are C₁₋₄hydroxyalkyl(meth)acrylate-((poly)lactide)ₙ compounds, wherein n is an integer between 1 and 10, preferably n is between 1 and 5 and most preferably n is between 2 and 4.

Also suitable are the reaction products of (meth)acrylic acid with aliphatic, cycloaliphatic or aromatic compounds that bear an epoxy functionality and that, optionally, further bear at least one (meth)acrylic functionality. It is also possible to use compounds obtained from the reaction of an aliphatic, cycloaliphatic or aromatic compound containing at least one carboxylic acid with another compound bearing an epoxy functionality and at least one (meth)acrylic functionality. Particularly suitable is the reaction of the glycidyl ester of a C₉-C₁₁ versatic acid with (meth)acrylic acid. From the above in particular poly(meth)acryloyl mono-hydroxy compounds, or compounds comprising one hydroxyl group and two or more (meth)acryloyl groups are preferred.

The amount of compounds (A2) used for the synthesis of the urethane (meth)acrylate oligomer or polymer is generally in the range of from 10 to 90 wt. %, preferably from 40 to 85 wt. % and more preferably from 50 to 80 wt. % relative to the total weight of compounds used to prepare the urethane (meth)acrylate oligomer or polymer.

Optionally, other hydroxyl functional compounds (A3) can be used for preparing the urethane (meth)acrylate oligomer or polymer. Compounds (A3) typically are polyols comprising at least two hydroxyl groups and in particular diols. In general compounds (A3) are saturated polyols. The polyol can be selected from low molecular weight polyols having a number average weight of less than 300, preferably less than 200 Daltons; from high molecular weight polyols having a number average molecular weight of at least 300, preferably at least 400, more preferably at least 500 Daltons; or from any mixtures thereof. The high molecular weight polyol preferably has a number average molecular weight of at most 5,000, preferably at most 2,000, more preferably at most 1,000 Daltons. Examples of suitable low molecular weight compounds include compounds like aliphatic or cycloaliphatic polyols such as ethyleneglycol (EG), propyleneglycol (PG), cyclohexane dimethanol (CHDM), glycerol (GLY), trimethylolpropane (TMP), ditrimethylolpropane (di-TMP), pentaerythrytol (PENTA), dipentaerythritol (di-PENTA), or any other renewable polyols like fatty dimer diols, and the like. Examples of high molecular weight polyols are polyester polyols, polyether polyols, polycarbonate polyols, polybutadiene polyols, polyacrylate polyols and silicone polyols, as well as combinations thereof. Preferred are polyester polyols, polycarbonate polyols and/or polyether polyols, having a molecular weight above 500 Daltons. Particularly preferred are polyhydroxylated polyester polyols. Examples of such compounds are well known in the art. Where present, compounds (A3) are generally used in an amount from 1 to 95 wt. %, preferably from 2 to 20 wt. %, more preferably from 3 to 10 wt. %, and most preferably from 5 to 10 wt. % relative to the total weight of compounds used to prepare the urethane (meth)acrylate oligomer or polymer.

Suitable urethane (meth)acrylate oligomers or polymers (A) are prepared from compounds (A1), (A2) and optional compound (A3) as identified above. Especially preferred are urethane (meth)acrylate oligomers or polymers that are obtained from the reaction of at least one polyisocyanate (A1) and at least one polymerizable ethylenically unsaturated compound (A2) containing at least one reactive group capable to react with isocyanate groups as described above, i.e. not comprising optional compound(s) (A3).

Typically urethane (meth)acrylate oligomers or polymers (A) that are used in the invention have a molecular weight Mw of between 400 and 20,000 Daltons. Usually the Mw is at most 5,000 Daltons, typically at most 2,000 Daltons, and most typically at most 1,000 Daltons. Molecular weights can be measured by gel permeation chromatography using polystyrene standards but most typically they are calculated from the target molecule.

Urethane (meth)acrylate oligomers or polymers (A) can have residual amounts of hydroxyl functions. In general the residual amount of hydroxyl functions is between 0 and 5 meq/g. Typically the residual amount of hydroxyl functions is at most 3 meq/g, more typically at most 1 meq/g.

In one embodiment, the at least one unsaturated urethane (meth)acrylate oligomer or polymer (A) is an unsaturated urethane (meth)acrylate oligomer, preferably an unsaturated aliphatic urethane acrylate oligomer.

The unsaturated groups of the at least one unsaturated urethane (meth)acrylate oligomer or polymer (A) may be selected from (meth)acryloyl groups. Preferred urethane (meth)acrylate oligomers or polymers comprise acryloyl groups.

The unsaturated urethane (meth)acrylate oligomer or polymer (A) has—on average—at least one unsaturated group, i.e. the average functionality corresponds to 1.

Preferred unsaturated urethane (meth)acrylate oligomers or polymers (A) have an average functionality of at least 2, preferably of at least 4, in particular of 6. This high unsaturated functionality allows to achieve a high crosslinking density upon curing and results in a high adhesion of the cured coating layer to the substrate.

Examples of suitable unsaturated urethane (meth)acrylate oligomer (A) are those commercialized as those commercialized as EBECRYL® 1290, EBECRYL® 220, EBECRYL® 244, EBECRYL® 270, EBECRYL® 264, EBECRYL® 294/25HD, EBECRYL® 4883, EBECRYL® 5129 and EBECRYL® 8210 (all available from Allnex Inc., USA), Laromer® UA19T, Laromer® 9033 and Laromer® 9047 (all available from BASF Corporation). Particularly preferred unsaturated urethane (meth)acrylate oligomers (A) are selected from EBECRYL® 5129 and/or EBECRYL® 244 and/or Laromer® UA19T and/or Laromer® 9033 and/or Laromer® 9047.

In one example, typical total amounts of the at least one unsaturated urethane (meth)acrylate oligomer or polymer in the inventive radiation curable coating composition include 1 to 15 wt. %, preferably 2 to 10 wt. %, more preferably 2.5 to 8 wt. %, very preferably 3 to 6 wt. %, based in each case on the total weight of the coating composition. In another example, total amounts of the at least one unsaturated urethane (meth)acrylate oligomer or polymer in the inventive radiation curable coating composition include 20 to 70 wt. %, preferably 25 to 65 wt. %, more preferably 30 to 60 wt. %, very preferably 40 to 50 wt. %, based in each case on the total weight of the coating composition.

### Unsaturated Acid-Functional (Meth)Acrylate Oligomer or Polymer (B):

Suitable acid-functional unsaturated (meth)acrylate oligomers or polymers (B) (sometimes also referred to in the art as “acid-functional acrylic oligomers” or “acid-functional acrylic polymers”) include oligomers which may be described as substances having an oligomeric acrylic backbone which is functionalized with at least one unsaturated group (which may be at a terminus of the oligomer or pendant to the acrylic backbone) and at least one acid group (which may be at a terminus of the oligomer or pendant to the acrylic backbone). With particular preference, the at least one unsaturated group is selected from (meth)acryloyl groups or allyl groups, in particular from (meth) acryloyl groups. The acid group is preferably selected from carboxylic acid groups, sulfonic acid groups, phosphonic acid groups, in particular from carboxylic acid groups. The acrylic backbone may be a homopolymer, random copolymer or block copolymer comprised of repeating units of acrylic monomers. The acrylic monomers may be any monomeric (meth)acrylate such as C₁-C₆ alkyl (meth)acrylates as well as functionalized (meth)acrylates such as (meth)acrylates bearing hydroxyl, carboxylic acid and/or epoxy groups. Unsaturated acid-functional acrylic (meth)acrylate oligomers may be prepared using any procedures known in the art, such as by oligomerizing monomers, at least a portion of which are functionalized with hydroxyl, carboxylic acid and/or epoxy groups (e.g., hydroxyalkyl(meth)acrylates, (meth)acrylic acid, glycidyl (meth)acrylate) to obtain a functionalized oligomer intermediate, which is then reacted with one or more (meth)acrylate-containing reactants to introduce the desired (meth)acrylate functional groups. The acid group(s) may be present on the monomers and/or the (meth)acrylate-containing reactants. Suitable functionalized oligomer intermediates include aliphatic and/or aromatic polyesters comprising at least one acid group, such as a carboxylic acid group, and optionally at least one hydrogen group, and (meth)acrylate oligomers comprising at least one acid group, such as a carboxylic acid group, and optionally at least one hydrogen group.

Exemplary (meth)acrylate-functionalized monomers, in particular the aforementioned reactants, may include ethoxylated bisphenol A di(meth)acrylates; triethylene glycol di(meth)acrylate; ethylene glycol di(meth)acrylate; tetraethylene glycol di(meth)acrylate; polyethylene glycol di(meth)acrylates; 1,4-butanediol diacrylate; 1,4-butanediol dimethacrylate; diethylene glycol diacrylate; diethylene glycol dimethacrylate, 1,6-hexanediol diacrylate; 1,6-hexanediol dimethacrylate; neopentyl glycol diacrylate; neopentyl glycol di(meth)acrylate; polyethylene glycol (600) dimethacrylate (where 600 refers to the approximate number average molecular weight of the polyethylene glycol portion); polyethylene glycol (200) diacrylate; 1,12-dodecanediol dimethacrylate; tetraethylene glycol diacrylate; triethylene glycol diacrylate, 1,3-butylene glycol dimethacrylate, tripropylene glycol diacrylate, polybutadiene diacrylate; methyl pentanediol diacrylate; polyethylene glycol (400) diacrylate; ethoxylated2 bisphenol A dimethacrylate (where the numeral following “ethoxylated” is the average number of oxyalkylene moieties per molecule); ethoxylated3 bisphenol A dimethacrylate; ethoxylated3 bisphenol A diacrylate; cyclohexane dimethanol dimethacrylate; cyclohexane dimethanol diacrylate; ethoxylated2 bisphenol A dimethacrylate; dipropylene glycol diacrylate; ethoxylated4 bisphenol A dimethacrylate; ethoxylated6 bisphenol A dimethacrylate; ethoxylatedx bisphenol A dimethacrylate; alkoxylated hexanediol diacrylates; alkoxylated cyclohexane dimethanol diacrylate; dodecane diacrylate; ethoxylated4 bisphenol A diacrylate; ethoxylatedio bisphenol A diacrylate; polyethylene glycol (400) dimethacrylate; polypropylene glycol (400) dimethacrylate; metallic diacrylates; modified metallic diacrylates; metallic dimethacrylates; polyethylene glycol (1000) dimethacrylate; methacrylated polybutadiene; propoxylated2 neopentyl glycol diacrylate; ethoxylated30 bisphenol A dimethacrylate; ethoxylated30 bisphenol A diacrylate; alkoxylated neopentyl glycol diacrylates; polyethylene glycol dimethacrylates; 1,3-butylene glycol diacrylate; ethoxylated2 bisphenol A dimethacrylate; dipropylene glycol diacrylate; ethoxylated4 bisphenol A diacrylate; polyethylene glycol (600) diacrylate; polyethylene glycol (1000) dimethacrylate; tricyclodecane dimethanol diacrylate; propoxylated2 neopentyl glycol diacrylate; diacrylates of alkoxylated aliphatic alcohols trimethylolpropane trimethacrylate; trimethylolpropane triacrylate; tris (2-hydroxyethyl) isocyanurate triacrylate; ethoxylated2 trimethylolpropane triacrylate; pentaerythritol triacrylate; ethoxylated3 trimethylolpropane triacrylate; propoxylated3 trimethylolpropane triacrylate; ethoxylated6 trimethylolpropane triacrylate; propoxylated6 trimethylolpropane triacrylate; ethoxylated9 trimethylolpropane triacrylate; alkoxylated trifunctional acrylate esters; trifunctional methacrylate esters; trifunctional acrylate esters; propoxylated3 glyceryl triacrylate; propoxylated glyceryl triacrylate; ethoxylatedis trimethylolpropane triacrylate; trifunctional phosphoric acid esters; trifunctional acrylic acid esters; pentaerythritol tetraacrylate; di-trimethylolpropane tetraacrylate; ethoxylatecb pentaerythritol tetraacrylate; pentaerythrilol polyoxyethylene tetraacrylate; dipentaerythritol pentaacrylate and pentaacrylate esters. Suitable unsaturated acid-functional acrylic (meth)acrylate oligomers are commercially available from Allnex Inc., USA under the product designated as EBECRYL® 524, EBECRYLI® 767 and EBECYL® 780, for example.

Typically unsaturated acid-functional (meth)acrylate oligomers or polymers (B) that are used in the invention have a dynamic viscosity of 5,000 to 15,000 mPa*s. Usually the dynamic viscosity is 5,500 to 12,000 mPa*s, typically 6,000 to 11,000 mPa*s and most typically 7,000 to 10,000 mPa*s. The dynamic viscosity is determined according to DIN EN ISO 3219:1194-10 at 60° C.

In one example, typical total amounts of the at least one unsaturated acid-functional (meth)acrylate oligomer or polymer (B) in the inventive radiation curable coating composition include 1 to 25 wt. %, preferably 5 to 20 wt. %, more preferably 7 to 15 wt. %, very preferably 8 to 12 wt. %, based in each case on the total weight of the coating composition. In another example, total amounts of the at least one unsaturated acid-functional (meth)acrylate oligomer or polymer (B) in the inventive radiation curable coating composition include 12 to 18 wt.-%, based on the total weight of the coating composition. In yet another example, total amounts of the at least one unsaturated acid-functional (meth)acrylate oligomer or polymer (B) in the inventive radiation curable coating composition include 1 to 10 wt.-%, in particular 4 to 8 wt.-%, based in each case on the total weight of the coating composition.

### Ethylenically Unsaturated Monomer (C):

The at least one ethylenically unsaturated monomer (C) has a high hydrophobicity, i.e. a calculated Hansen solubility parameter δₚ of less than 5 MPa^{1/2}. The Hansen solubility parameter is calculated according to the method described in “Pencil and Paper Estimation of Hansen Solubility Parameters” by Didier Mathieu, ACS Omega, 2018, Vol. 3, pages 17049 to 17056 and references cited therein. Briefly, the Hansen solubility parameter δₚ is obtained from the cohesive energy Eₚ and the molar volume Vₘ according to equation (1)

$${δ}_{P} = \sqrt{\frac{{E}_{P}}{{V}_{m}}} . \qquad ( 1 )$$

The cohesive energy can be calculated from the sum of additive contributions of molar fragments of the respective monomer according to equation (2) using the parameters given in Table 2 on page 17053 of the above-mentioned reference

$${E}_{P} = {\sum }_{G} {N}_{G} {E}_{k} ( G ) \qquad ( 2 )$$

in which
N_{G} is the number of occurrences of group G in the monomer and
Eₖ(G) is the parameter for group G given in Table 2 on page 17053 of the reference.

The molar volume Vₘ can be calculated according to the method described in “Reliable and Versatile Model for the Density of Liquids Based on Additive Volume Increments” by Didier Mathieu et. al, Ind. Eng. Chem. Res., 2016, Vol. 55, pages 12970 to 12980 using equations (3) and (4) in combination with the parameters listed in Tables 1 and 2 of this reference

$${V}_{m} = {\sum }_{k} V ( {Z}_{k} , {n}_{k} , {n}_{{H}_{k}} ) + {V}_{r} \qquad ( 3 )$$

in which

V(Zₖ, nₖ, n_{H}_{ₖ}) is the molar volume increment for all non-hydrogen atoms k that share a common atomic number (Zₖ=Z) is a common coordination number (nₖ=n) and a common number of hydrogen atoms attached ((n_{H}_{ₖ}=n_{H})) and Vᵣ is a ring correction.

The ring correction is obtained with equation (4) as follows

$${V}_{r} = {n}_{< 5} {V}_{< 5} + {n}_{5} {V}_{5} + {n}_{6} {V}_{6} + {n}_{> 6} {V}_{> 6} + {n}_{a} {V}_{a} \qquad ( 4 )$$

in which
n_{<5}, n₅, n₆ and n_{>6} represent the number of rings with, respectively, <5, 5, 6 and >6 atoms,
V_{<5}, V₅, V₆ and V_{>6} are the corresponding volume increments,
nₐ is the number of aromatic rings in the monomer, and
Vₐ is a volume increment that accounts for the role of aromaticity on the molar volume.

In one example, the at least one ethylenically unsaturated monomer (C) is present in a total amount of 0.1 to 35 wt. %, preferably 5 to 40 wt. %, even more preferably 10 to 35 wt. %, even more preferably 15 to 30 wt. %, very preferably 20 to 25 wt. %, based in each case on the total weight of the coating composition. In another example, the at least one ethylenically unsaturated monomer (C) is present in a total amount of 0.1 to 11 wt.-%, preferably of 3 to 10 wt. %, based in each case on the total weight of the coating composition.

The at least one ethylenically unsaturated monomer (C) has a calculated Hansen solubility parameter δₚ of less than 5 MPa^{1/2}. In preferred embodiments, the at least one ethylenically unsaturated monomer (C) has a calculated Hansen solubility parameter δₚ of less than 4.5 MPa^{1/2}, preferably of 1 to 4.5 MPa^{1/2}, very preferably of 3.5 to 4.5 MPa^{1/2}.

Ethylenically unsaturated monomers (C) comprise at least one unsaturated group. With preference, the unsaturated groups of the at least one ethylenically unsaturated monomer (C) are selected from (meth)acryloyl groups, in particular from acryloyl groups.

Suitable hydrophobic ethylenically unsaturated monomers (C) include ethylenically unsaturated cycloaliphatic monomers and/or ethylenically unsaturated aliphatic monomers having exactly one unsaturated group. Examples of ethylenically unsaturated cycloaliphatic monomers include tert-butyl cyclohexyl (meth)acrylate, cyclohexyl (meth)acrylate, cyclopentyl (meth)acrylate, isobornyl (meth)acrylate and 3,5,5-trimethyl cyclohexyl (meth)acrylate. Examples of ethylenically unsaturated aliphatic monomers having exactly one unsaturated group include isodecyl (meth)acrylate, isooctyl (meth)acrylate, octyl decyl (meth)acrylate, tridecyl (meth)acrylate and C₁₂-C₁₅ alkyl (meth)acrylate.

With particular preference, the at least one ethylenically unsaturated monomer (C) is isobornyl (meth)acrylate, in particular isobornyl acrylate. Isobornyl acrylate has a calculated Hansen solubility parameter δₚ of 4.2 MPa^{1/2} and results, in combination with the unsaturated acid-functional (meth)acrylate oligomer or polymer (B) and the at least one ethylenically unsaturated monomer (D) described below, in an improved surface roughness of the substrate, an improved adhesion to the substrate as well as an improved interlayer adhesion to further coating layers.

In a particular preferred embodiment, the radiation curable coating composition comprises exactly one ethylenically unsaturated monomer (C) which is selected from isobornyl acrylate.

### Ethylenically Unsaturated Monomer (D):

The at least one ethylenically unsaturated monomer (D) has a high hydrophilicity, i.e. a calculated Hansen solubility parameter δₚ of at least 5 MPa^{1/2}. The Hansen solubility parameter is calculated according to the method described in connection with the ethylenically unsaturated monomer (C).

To achieve the improved adhesion of coating layers obtained from the radiation curable coating composition to the substrate, the improved interlayer adhesion as well as the improved surface roughness of substrates coated with radiation curable coating composition the at least one unsaturated monomer (D) must be present in a total amount of more than 20 wt. %, based on the total weight of the radiation curable coating composition. In one example, the at least one ethylenically unsaturated monomer (D) is present in a total amount of 25 to 60 wt. %, more preferably 28 to 55 wt. %, even more preferably 30 to 50 wt. %, very preferably 35 to 45 wt. %, based in each case on the total weight of the coating composition. In another example, the at least one ethylenically unsaturated monomer (D) is present in a total amount of 60 to 80 wt.-%, in particular of 60 to 65 wt.-%, based in each case on the total weight of the coating composition. In yet another example, the at least one ethylenically unsaturated monomer (D) is present in a total amount of 15 to 25 wt.-%, based on the total weight of the coating composition.

The at least one ethylenically unsaturated monomer (D) preferably has a calculated Hansen solubility parameter δₚ of at least 5.5 MPa^{1/2}, in particular of 5.6 to 8 MPa^{1/2}.

Monomers (D) comprise at least one ethylenically unsaturated group. Such groups may be selected from (meth)acryloyl groups, in particular from acryloyl groups.

Suitable ethylenically unsaturated monomers (D) include ethylenically unsaturated hydroxy-functional monomers, ethylenically unsaturated alkoxylated monomers, ethylenically unsaturated aliphatic monomers having at least 2 ethylenically unsaturated groups and mixtures thereof. Further suitable ethylenically unsaturated monomers (D) include ethylenically unsaturated cyclic monomers. Said ethylenically unsaturated cyclic monomers may be ethylenically unsaturated aliphatic cyclic monomers or may be ethylenically unsaturated cyclic monomers comprising at least one heteroatom, such as oxygen, nitrogen and sulfur.

With particular preference, the radiation curable coating composition comprises a mixture of the aforementioned ethylenically unsaturated hydroxy-functional monomers, ethylenically unsaturated alkoxylated monomers and ethylenically unsaturated aliphatic monomers having at least 2 ethylenically unsaturated groups. In another example, the radiation curable coating composition comprises a mixture of the aforementioned ethylenically unsaturated alkoxylated monomers, ethylenically unsaturated aliphatic monomers having at least 2 ethylenically unsaturated groups and ethylenically unsaturated cyclic monomers. The use of this mixture in combination with the unsaturated acid-functional (meth)acrylate oligomer or polymer (B) and the previously unsaturated monomer (C) results in improved surface roughness of substrates coated with the radiation curable coating composition as well as and improved adhesion of the radiation curable coating layer to the substrate and optionally improved interlayer adhesion of further coating layers being present on top of the radiation curable coating layer.

In one example, the radiation curable coating composition comprises a weight ratio of ethylenically unsaturated hydroxy-functional monomers to ethylenically unsaturated alkoxylated monomers to ethylenically unsaturated aliphatic monomers having at least 2 ethylenically unsaturated groups of 2:1:0.4 to 1:2:0.6, preferably of 1:1:0.4 to 1:1:0.7. In another example, the radiation curable coating composition comprises a weight ratio of ethylenically unsaturated hydroxy-functional monomers to ethylenically unsaturated alkoxylated monomers to ethylenically unsaturated aliphatic monomers having at least 2 ethylenically unsaturated groups of 1:1:4 to 1:1:8. In yet another example, the radiation curable coating composition comprises a weight ratio of ethylenically unsaturated alkoxylated monomers to ethylenically unsaturated aliphatic monomers having at least 2 ethylenically unsaturated groups to ethylenically unsaturated cyclic monomers of 4:1:5 to 25:1:15.

The ethylenically unsaturated hydroxy-functional monomer may be present in the radiation curable coating composition in a total amount of 5 to 25 wt. %, preferably 10 to 20 wt. %, very preferably 12 to 18 wt. %, based in each case on the total weight of the coating composition. Suitable ethylenically unsaturated hydroxy-functional monomers include 2-hydroxyethyl (meth)acrylate, 2-hydroxypropyl (meth)acrylate, 3-hydroxypropyl (meth)acrylate, 3-hydroxybutyl (meth)acrylate and 4-hydroxybutyl (meth)acrylate. With particular preference, the radiation curable coating composition comprise exactly one ethylenically unsaturated hydroxy-functional monomer selected from 4-hydroxybutyl acrylate.

The ethylenically unsaturated alkoxylated monomer may be present in the coating composition in a total amount of 5 to 25 wt. %, preferably 10 to 20 wt. %, very preferably 12 to 18 wt. %, based in each case on the total weight of the coating composition. Suitable ethylenically unsaturated alkoxylated monomers include ethylenically unsaturated ethoxylated and propoxylated monomers, in particular ethylenically unsaturated alkoxylated monomers comprising at least two unsaturated groups. In one example, the radiation curable coating composition comprise exactly one ethylenically unsaturated alkoxylated monomer selected from dipropylenglycol diacrylate. In another example, the radiation curable coating composition comprises exactly two ethylenically unsaturated alkoxylated monomer selected from dipropylenglycol diacrylate and tripropylene glycol diacrylate.

In one example, the ethylenically unsaturated aliphatic monomer having at least two ethylenically unsaturated groups is present in the coating composition in a total amount of 1 to 20 wt. %, preferably 2 to 15 wt. %, very preferably 5 to 10 wt. %, based in each case on the total weight of the coating composition. In another example, the ethylenically unsaturated aliphatic monomer having at least two ethylenically unsaturated groups is present in the coating composition in a total amount of 0.1 to 5 wt.-%, preferably of 0.5 to 2.5 wt.-%, based in each case on the total weight of the coating composition. In yet another example, the ethylenically unsaturated aliphatic monomer having at least two ethylenically unsaturated groups is present in the coating composition in a total amount of 20.5 to 35 wt.-%, preferably of 25 to 30 wt.-%, based in each case on the total weight of the coating composition. Suitable ethylenically unsaturated aliphatic monomers having at least two ethylenically unsaturated groups include aliphatic di(meth)acrylates, such as butane-1,4-diol di(meth)acrylate and hexane-1,6-diol di(meth)acrylate, and (meth)acrylic acid esters of alcohols comprising at least three hydroxyl groups, such as trimethylolpropane triacrylate, pentaerythritol triacrylate and pentaerythritol tetracrylate. With particular preference, the radiation curable coating compositions comprise at least one of following unsaturated aliphatic monomers having at least two ethylenically unsaturated groups: hexandiol diacrylate, trimethylolpropane triacrylate, pentaerythritol triacrylate and pentaerythritol tetracrylate.

The combination of unsaturated acid-functional (meth)acrylate oligomer or polymer (B) with the at least one hydrophobic unsaturated monomer (C), in particular isobornyl acrylate, and a mixture of hydrophilic unsaturated monomers (D), in particular 4-hydroxybutyl acrylate, dipropylenglycol diacrylate, hexandiol diacrylate and optionally pentaerythritol triacrylate, trimethylolpropane triacrylate and pentaerythritol tetracrylate or dipropylenglycol diacrylate, trimethylolpropane triacrylate, tripropylene glycol diacrylate, trimethylolpropanformalacrylat and optionally hexandiol diacrylate, in the inventive radiation curable coating composition results in an improved surface roughness of substrates coated with said coating composition. Moreover, the adhesion, especially the wet adhesion, of the radiation curable coating layer to the substrate is increased. The radiation curable coating layer can be overcoated with commonly known water-borne and solvent-borne coating compositions without further pretreatment steps and results in an improved adhesion, especially wet-adhesion, of the resulting multilayer coating to the substrate as well as an improved interlayer adhesion between the radiation curable coating layer and further coating layers of the multilayer coating.

### Optional Photoinitiator (E):

According to a preferred embodiment, the polymerization or the cross linking of the radiation curable coating compositions is initiated using at least one photoinitiator (E). The at least one photoinitiator may be present in a total amount of 1 to 15 wt. %, preferably 2 to 12 wt. %, more preferably 3 to 10 wt. %, very preferably 4 to 7 wt. %, based in each case on the total weight of the coating composition.

Suitable photoinitiators include UV-photoinitiators. These are compounds which—under irradiation by visible or UV-light—decompose into radicals and thereby initiate the polymerization of compounds (A), (B), (C) and (D) of the radiation curable coating composition. Examples of such UV-photoinitiators include compounds selected from the group of camphor quinone, benzophenone, benzophenone derivatives, thioxanthones, thioxanthone derivatives, ketal compounds, acetophenone, acetophenone derivatives, 4-aroyl-1,3-dioxolanes, benzoin alkyl ethers and benzil ketals, phenylglyoxalic esters and derivatives thereof, ketosulfones, oximeesters, peresters, monoacyl phosphine oxides, bisacylphosphine oxides, halomethyltriazines, ferrocenium compounds, titanocenes, and mixtures thereof. With particular preference, a mixture of oxo-phenyl-acetic acid 1-methyl-2-[2-(2-oxo-2-phenyl-acetoxy)-propoxy]-ethyl ester and oxy-phenyl-acetic acid 2-[2-hydroxy-ethoxy]-ethyl ester is used as photoinitiator (E). This mixture is commercially available as Omnirad 754 from IGM Resins.

According to a less preferred alternative embodiment, the polymerization or the cross linking of the radiation curable coating composition is initiated by electron beam (EB). In this case, a photoinitiator is not necessary and is preferably not present, i.e. the radiation curable coating compositions of this embodiment comprise 0% by weight, based on the total weight of the coating composition, of photoinitiator (E).

### Optional Reactive Diluent (F):

According to a preferred embodiment, the inventive radiation curable coating composition does not contain other reactive diluents (F). By “other” is meant reactive diluents (F) being different from monomers (C) and (D) previously described. The term “reactive diluent” refers to refers to low weight monomers which are able to participate in a polymerization reaction to form a polymeric material. The weight average molecular weight Mw of such monomer compounds preferably is less than 1,000 g/mol and more preferably less than 750 g/mol, as determined by GPC.

According to a less preferred alternative embodiment, the inventive radiation curable coating composition comprises at least one other reactive diluent (F). The use of the at least one other reactive diluent allows to adjust the viscosity of the radiation curable coating composition to the respective range required for the desired application type and helps to achieve good levelling properties of the coating layer. Typical concentrations of reactive diluents include 0.5 to 75 wt. % such as 5 to 60 wt. %, based on the total weight of the coating composition.

Suitable reactive thinners comprise one or several free radically polymerizable groups, preferably (meth)acrylic group and include
(meth)acrylates, which are derived from saturated alcohols, like for example methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate,
(meth)acrylates, which are derived from unsaturated alcohols, like for example oleyl (meth)acrylate, 2-propionyl (meth)acrylate, allyl (meth)acrylate, vinyl (meth)acrylate, aryl (meth)acrylates, like benzyl (meth)acrylate or phenyl (meth)acrylate, whereby the aryl group can be without a substituent or may have until four substituents,
vinyloxyethoxyethyl (meth)acrylate;
amides and nitriles of (meth)acrylic acid, like N-(3-dimethyl aminopropyl)(meth)acrylamide, N-(diethylphosphono)(meth)acrylamide, 1-methacryloylamido-2-methyl-2-propanol;
sulphur containing methacrylates, like ethyl sulfinyl ethyl (meth)acrylate, 4-thiocyanato butyl (meth)acrylate, ethyl sulfonyl ethyl (meth)acrylate, thiocyanato methyl (meth)acrylate, methyl sulfinyl methyl (meth)acrylate and bis((meth)acryloyl oxyethyl)sulfide;
monomers bearing at least one (meth)acrylate and one allylic group such as allyl (meth)acrylate and other allyl (meth)acrylates bearing a substituted allylic group, in particular substituted by an alkyl group preferably a methyl group, like 2-methyl-allyl acrylate or 2-methyl-allyl methacrylate or allyl polyether (meth)acrylates such as allylpolyethylene glycol methacrylates or acrylates; and
mixtures thereof

### Optional Additive (G):

The inventive radiation curable coating composition may further contain at least one additive (G). Such additives may be present in a total amount of 0.1 to 15 wt. %, preferably 0.1 to 10 wt. %, based in each case on the total weight of the coating composition. Suitable additives include pigments, matting agents, adhesion promoters, silicones, light stabilizers such as HALS compounds, benzotriazoles or oxalanilides; rheology modifiers such as sagging control agents (urea crystal modified resins), organic thickeners and inorganic thickeners; free-radical scavengers; slip additives; polymerization inhibitors; defoamers; wetting agents; fluorine compounds; leveling agents; film-forming auxiliaries such as cellulose derivatives; fillers, such as nanoparticles based on silica, alumina or zirconium oxide; flame retardants; and mixtures thereof.

Suitable color pigments and effect pigments are known to those skilled in the art and are described, for example, in Rompp-Lexikon Lacke und Druckfarben, Georg Thieme Verlag, Stuttgart, New York, 1998, pages 176 and 451. The terms “coloring pigment” and “color pigment” are interchangeable, just like the terms “visual effect pigment” and “effect pigment”. Examples of inorganic coloring pigments include (i) white pigments, such as titanium dioxide, zinc white, colored zinc oxide, zinc sulfide, lithopone; (ii) black pigments, such as iron oxide black, iron manganese black, spinel black, carbon black; (iii) color pigments, such as ultramarine green, ultramarine blue, manganese blue, ultramarine violet, manganese violet, iron oxide red, molybdate red, ultramarine red, iron oxide brown, mixed brown, spinel and corundum phases, iron oxide yellow, bismuth vanadate; (iv) filer pigments, such as silicon dioxide, quartz flour, aluminum oxide, aluminum hydroxide, natural mica, natural and precipitated chalk, barium sulphate and (vi) mixtures thereof.

Examples of organic coloring pigments include (i) monoazo pigments such as C.I. Pigment Brown 25, C.I. Pigment Orange 5, 36 and 67, C.I. Pigment Orange 5, 36 and 67, C.I. Pigment Red 3, 48:2, 48:3, 48:4, 52:2, 63, 112 and 170 and C.I. Pigment Yellow 3, 74, 151 and 183; (ii) diazo pigments such as C.I. Pigment Red 144, 166, 214 and 242, C.I. Pigment Red 144, 166, 214 and 242 and C.I. Pigment Yellow 83; (iii) anthraquinone pigments such as C.I. Pigment Yellow 147 and 177 and C.I. Pigment Violet 31; (iv) benzimidazole pigments such as C.I. Pigment Orange 64; (v) quinacridone pigments such as C.I. Pigment Orange 48 and 49, C.I. Pigment Red 122, 202 and 206 and C.I. Pigment Violet 19; (vi) quinophthalone pigments such as C.I. Pigment Yellow 138; (vii) diketopyrrolopyrrole pigments such as C.I. Pigment Orange 71 and 73 and C.I. Pigment Red, 254, 255, 264 and 270; (viii) dioxazine pigments such as C.I. Pigment Violet 23 and 37; (ix) indanthrone pigments such as C.I. Pigment Blue 60; (x) isoindoline pigments such as C.I. Pigment Yellow 139 and 185; (xi) isoindolinone pigments such as C.I. Pigment Orange 61 and C.I. Pigment Yellow 109 and 110; (xii) metal complex pigments such as C.I. Pigment Yellow 153; (xiii) perinone pigments such as C.I. Pigment Orange 43; (xiv) perylene pigments such as C.I. Pigment Black 32, C.I. Pigment Red 149, 178 and 179 and C.I. Pigment Violet 29; (xv) phthalocyanine pigments such as C.I. Pigment Violet 29, C.I. Pigment Blue 15, 15:1, 15:2, 15:3, 15:4, 15:6 and 16 and C.I. Pigment Green 7 and 36; (xvi) aniline black such as C.I. Pigment Black 1; (xvii) azomethine pigments; and (xviii) mixtures thereof.

Examples of effect pigments include (i) plate-like metallic effect pigments such as plate-like aluminum pigments, gold bronzes, fire-colored bronzes, iron oxide-aluminum pigments; (ii) pearlescent pigments, such as metal oxide mica pigments; (iii) plate-like graphite pigments; (iv) plate-like iron oxide pigments; (v) multi-layer effect pigments from PVD films; (vi) liquid crystal polymer pigments; and (vii) mixtures thereof.

### Optional Solvent (H):

The inventive radiation curable coating composition may further contain at least one solvent (H). Suitable solvents (H) include aprotic solvents, such as aliphatic and/or aromatic hydrocarbons, ketones, esters, amides, methylal, butylal, 1,3-dioxolane, glycerol formal, hydrocarbons and mixtures thereof, or protic solvents, such as alcohols. Preferred aprotic solvents (H) include esters, in particular ethyl acetate. Preferred protic solvents (H) include alcohols, in particular 2-methoxy-1-propanol.

The at least one solvent (H), in particular aprotic and/or protic solvents, such as ethyl acetate and/or 2-methoxy-1-propanol, are typically used to adjust the viscosity of the radiation curable coating composition to the respective range required for the desired application type and help to achieve good levelling properties of the coating layer.

Typical amounts of solvents (H) include total amounts of 5 to 15 wt. %, preferably 8 to 12 wt. %, based in each case on the total weight of the coating composition.

### Preferred Embodiments of the Inventive Radiation Curable Coating Compositions:

According to a first preferred embodiment, the inventive radiation curable coating composition comprises at least components (A) to (E) and (H), with the sum of wt. % of all components being present in the inventive radiation curable coating composition being 100%.

According to a second preferred embodiment, the inventive radiation curable coating composition comprises components (A) to (E), (G) and (H), with the sum of wt. % of all components being present in the inventive radiation curable coating composition being 100%.

According to a third preferred embodiment, the inventive radiation curable coating composition consists of components (A) to (D) and optionally (E), (G) and (H), with the sum of wt. % of components (A) to (D) and optionally (E), (G) and (H) being 100%.

According to a fourth preferred embodiment, the inventive radiation curable coating composition consists of components (A) to (E), (G) and (H), with the sum of wt. % of components (A) to (E), (G) and (H) being 100%.

According to a fifth preferred embodiment, the inventive radiation curable coating composition consists of components (A) to (E) and (H), with the sum of wt. % of components (A) to (E) and (H) being 100%.

### Further Properties of the Inventive Radiation Curable Coating Composition:

According to a preferred embodiment, the inventive radiation curable coating composition is a primer coating composition. The term “primer coating composition” denotes a coating composition used to prepare the first coat of a coating system comprising at least one coating layer applied to a substrate or an existing coating system. Such primer coating compositions are used to provide adhesion for the entire coating system, i.e. in addition to the primer, also the subsequent layers being present on top of the primer coating layer.

The viscosity of the inventive radiation curable coating composition is primarily guided by the viscosity required for application, more particularly for spray application, and may be adjusted—as previously described—by addition of solvents (H) and/or reactive diluents (F). Suitable viscosities for spray application include viscosities of 5 to 15 seconds at 23° C., determined according to DIN EN ISO 2431:2020-02 using a DIN 6 cup.

The solids content of the radiation curable coating compositions of the invention may vary according to the requirements of the individual case. The solids content is guided primarily by the viscosity required for application, more particularly for spray application, as previously described. The solids content of the coating composition of the invention is preferably at least 74 wt. %, more preferably 75 to 90 wt. %. “Solids content” (nonvolatile content) is understood to mean that proportion by weight which remains as a residue on evaporation under fixed conditions.

### Inventive Method:

The present invention is also directed to a method of coating an object with the inventive radiation curable coating compositions in which the inventive radiation curable coating compositions are applied to at least part of a surface of the object to be coated, a coating film is formed form the inventive radiation curable coating composition and said coating film is afterwards cured. On this cured coating layer, it is possible to apply and cure at least one further pigmented or unpigmented coating composition without any further treatment steps, such as sanding, without negatively influencing the adhesion of the resulting coating system.

With particular preference, the object to be coated is selected from plastic substrates, such as plastic substrates resulting from AM processes. Suitable plastic substrates include (i) thermoplastics, such as polyolefins, poly(meth)acrylates, polystyrene, polyvinyl chloride (PVC), polyamides, polyurethanes, polycarbonates, polylactic acid (PLA), saturated polyesters like PET (polyethylene terephthalate), ethylene-propylene-diene (EPDM), acrylonitrile-styrene-butadiene (ABS), vinyl polymers selected from halogenated polymers other than PVC, (ii) thermosets, such as phenol resins, epoxy resins, unsaturated poly ester resins, resins with furanic groups, resins with urea groups, melamine resins, poly urethane resins, (iii) mixtures of the aforementioned thermoplastics and thermosets, (iv) fiber-reinforced polymers or composites derived from the above-cited thermoplastics or thermosets, in particular polyamides and polypropylenes.

### Step (1):

In step (1) of the inventive method, the inventive radiation curable coating composition is applied on at least part of the surface of the substrate. The application of a coating composition to at least part of the surface of an object is understood as follows: the coating composition in question is applied such that the coating film produced from said composition is disposed on at least part of the surface of the object but need not necessarily be in direct contact with the surface of the object. For example, between the coating film and the surface of the object, there may be other coats disposed. Preferably, the radiation curable coating composition is applied directly to at least part of the surface of the object in step (1), meaning that the coating film produced from applying the inventive radiation curable coating composition is in direct contact with the surface of the object.

The inventive radiation curable coating compositions may be applied by the methods known to the skilled person for applying liquid coating materials, as for example by dipping, knifecoating, spraying, rolling, or the like. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference, the inventive radiation curable coating composition is applied via pneumatic spray application or electrostatic spray application. The inventive composition is applied such that the cured coating layer preferably has a film thickness of 20 to 200 μm.

### Step (2):

In step (2) of the inventive method, a coating film is formed from the radiation curable coating composition applied in step (1). The formation of a film from the applied coating composition can be effected, for example, by irradiating the applied coating composition with an radiation source.

Examples of suitable radiation sources are low-pressure, medium-pressure, and high-pressure mercury emitters, fluorescent tubes, pulsed emitters, metal halide emitters (halogen lamps), lasers, LEDs, and also electronic flash installations or excimer emitters. It is of course also possible to use two or more radiation sources-two to four, for example. These sources may also each emit in different wavelength ranges. With particular preference, a UV radiation source is used in step (2) of the inventive process.

The film formation is preferably performed at an intensity of 100 to 300 mJ/cm², in particular of 150 to 210 mJ/cm². The intensity is not sufficient to fully cure the formed film, as described in connection with step (3). Thus, after step (2), the coating film is not in the service-ready state, i.e. it is still soft and tacky, and undergoes further changes in its property upon exposure to curing conditions as described below.

### Step (3):

In step (3) of the inventive method, the coating film formed in step (2) is cured. Curing of the film formed after step (2) is preferably effected by means of radiation curing, preferably by means of UV light and/or electron beam curing (EBC).

Examples of suitable radiation sources for the radiation curing are the ones previously mentioned in connection with step (2). Electron beam curing is usually effected with an electron accelerator. Individual accelerators are usefully characterized by their energy, power, and type. Low-energy accelerators provide beam energies from about 150 keV to about 2.0 MeV. Medium-energy accelerators provide beam energies from about 2.5 to about 8.0 MeV. High-energy accelerators provide beam energies greater than about 9.0 MeV. Accelerator power is a product of electron energy and beam current. Such powers range from about 5 to about 300 KW. The main types of accelerators are: electrostatic direct-current (DC), electrodynamic DC, radiofrequency (RF) linear accelerators (LINACS), magnetic-induction LINACs, and continuous-wave (CW) machines.

With particular preference, a UV-light is used in step (3) of the inventive process. If curing is performed by UV radiation, the intensity used for curing in step (3) is preferably 100 to 1,000 mJ/cm². It may be preferred if the curing is performed in two steps with different intensities, namely a first intensity of 160 to 210 mJ/cm² followed by second intensity of 750 to 1,000 mJ/cm². Performing the curing in two steps with different intensities may be beneficial with respect to the degassing of the coating composition during curing and the adhesion of the cured coating film to the underlying substrate or coating layer(s).

The statements made above, however, do not rule out that the inventive coating composition can additionally be cured under further curing conditions, for example thermal curing conditions.

The dry film thickness of the cured primer coating layer obtained after step (iii) may vary greatly and primarily depends on the surface roughness of the substrate. It may range, for example, from 20 to 200 μm, preferably from 20 to 100 μm. Film thicknesses of up to 100 or 200 μm may be obtained by repeating steps (i) and (ii) of the inventive method at least once, in particular at least twice.

### Optional Step (iv):

In optional step (iv) of the inventive method, at least one further coating composition is applied onto the cured coating layer obtained after step (iii). Application of further coating layers can be effected without further pretreatment processes, such as sanding etc.

After application of said at least one further coating composition, a film is formed from said coating composition and said film is afterwards cured. Suitable further coating compositions include commonly known water-borne and solvent-borne primer-surfacer compositions, basecoat compositions, topcoat compositions, clearcoat compositions or tinted clearcoat compositions.

It is also possible to apply more than one further coating film by repeating step (iv) using either the same or different coating compositions. Application of more than one further coating composition can either be performed wet-in-wet, i.e. without intermediate curing, or after curing of the previously applied further coating composition

The further coating composition may be applied by the methods known to the skilled person for applying liquid coating materials, as previously described in connection with step (i).

The formation of a film from the applied coating composition can be effected, for example, by flashing off and/or drying the applied coating composition at room temperature or elevated temperatures.

The curing can in principle be carried out at temperatures of 20 to 100° C., for example, in particular 20 to 60° C., for a duration of 5 to 60 minutes, preferably 20 to 40 minutes. If more than one coating layer is produced in step (iv), said layers can either be cured separately or jointly. Joint curing is preferred with respect to the overall energy consumption being lower when using a joint curing step.

What has been said about the inventive coating composition applies mutatis mutandis with respect to further preferred embodiments of the inventive method.

### Inventive Coated Object:

After the end of the method of the invention, the result is a coated object of the invention.

### Inventive Use:

The present invention is also directed to the use of the inventive radiation curable coating composition to improve the surface roughness of plastic substrates, in particular plastic substrates produced by additive manufacturing processes.

What has been said about the inventive coating composition applies mutatis mutandis with respect to further preferred embodiments of the inventive use.

The invention is described in particular by the following clauses:
1. Radiation curable coating composition comprising-based on the total weight of the coating composition—
   a) at least one unsaturated urethane (meth)acrylate oligomer or polymer (A),
   b) at least one unsaturated acid-functional acrylic (meth)acrylate oligomer or polymer (B),
   c) at least one ethylenically unsaturated monomer (C) having a calculated Hansen solubility parameter δₚ of less than 5 MPa^{1/2},
   d) more than 20 wt. % of at least one ethylenically unsaturated monomer (D) having a calculated Hansen solubility parameter δₚ of at least 5 MPa^{1/2}, and
   e) optionally at least one photoinitiator (E)
   wherein the solubility parameter δₚ is calculated according to the method described in “Pencil and Paper Estimation of Hansen Solubility Parameters” by Didier Mathieu, ACS Omega, 2018, Vol. 3, pages 17049 to 17056.
2. Radiation curable coating composition according to clause 1, wherein the at least one unsaturated urethane (meth)acrylate oligomer or polymer (A) is an unsaturated urethane (meth)acrylate oligomer, preferably an unsaturated aliphatic urethane acrylate oligomer.
3. Radiation curable coating composition according to clause 1 or 2, wherein the unsaturated groups of the at least one unsaturated urethane (meth)acrylate oligomer or polymer (A) are selected from (meth)acryloyl groups, in particular from acryloyl groups.
4. Radiation curable coating composition according to any of the preceding clauses, wherein the at least one unsaturated urethane (meth)acrylate oligomer or polymer (A) has an average functionality of at least 2, preferably of at least 4, in particular of 6.
5. Radiation curable coating composition according to any of the preceding clauses, wherein the at least one unsaturated urethane (meth)acrylate oligomer or polymer (A) is present in a total amount of 1 to 15 wt. %, preferably 2 to 10 wt. %, more preferably 2.5 to 8 wt. %, very preferably 3 to 6 wt. %, based in each case on the total weight of the coating composition, or wherein the at least one unsaturated urethane (meth)acrylate oligomer or polymer (A) is present in a total amount of 20 to 70 wt. %, preferably 25 to 65 wt. %, more preferably 30 to 60 wt. %, very preferably 40 to 50 wt. %, based in each case on the total weight of the coating composition.
6. Radiation curable coating composition according to any of the preceding clauses, wherein the unsaturated groups of the at least one unsaturated acid-functional acrylic (meth)acrylate oligomer or polymer (B) are selected from (meth)acryloyl groups or allyl groups, in particular from (meth) acryloyl groups.
7. Radiation curable coating composition according to any of the preceding clauses, wherein the at least one unsaturated acid-functional acrylic (meth)acrylate oligomer or polymer (B) is present in a total amount of 1 to 25 wt. %, preferably 5 to 20 wt. %, more preferably 7 to 15 wt. %, very preferably 8 to 12 wt. %, based in each case on the total weight of the coating composition, or wherein the at least one unsaturated acid-functional (meth)acrylate oligomer or polymer (B) is present in a total amount of 12 to 18 wt.-%, based on the total weight of the coating composition, or wherein the at least one unsaturated acid-functional (meth)acrylate oligomer or polymer (B) is present in a total amount of 1 to 10 wt.-%, in particular 4 to 8 wt.-%, based in each case on the total weight of the coating composition.
8. Radiation curable coating composition according to any of the preceding clauses, wherein the at least one ethylenically unsaturated monomer (C) is present in a total amount of 0.1 to 35 wt. %, preferably 5 to 40 wt. %, more preferably 10 to 35 wt. %, even more preferably 15 to 30 wt. %, very preferably 20 to 25 wt. %, based in each case on the total weight of the coating composition, or wherein the at least one ethylenically unsaturated monomer (C) is present in a total amount of 0.1 to 11 wt.-%, preferably of 3 to 10 wt. %, based in each case on the total weight of the coating composition.
9. Radiation curable coating composition according to any of the preceding clauses, wherein the at least one ethylenically unsaturated monomer (C) has a calculated Hansen solubility parameter δₚ of less than 4.5 MPa^{1/2}, preferably of 1 to 4.5 MPa^{1/2}, very preferably of 3.5 to 4.5 MPa^{1/2}.
10. Radiation curable coating composition according to any of the preceding clauses, wherein the unsaturated groups of the at least one ethylenically unsaturated monomer (C) are selected from (meth)acryloyl groups, in particular from acryloyl groups.
11. Radiation curable coating composition according to any of the preceding clauses, wherein the at least one ethylenically unsaturated monomer (C) is selected from ethylenically unsaturated cycloaliphatic monomers and/or ethylenically unsaturated aliphatic monomers.
12. Radiation curable coating composition according to any of the preceding clauses, wherein the at least one ethylenically unsaturated monomer (C) is isobornyl (meth)acrylate, in particular isobornyl acrylate.
13. Radiation curable coating composition according to any of the preceding clauses, wherein the at least one ethylenically unsaturated monomer (D) is present in a total amount of 25 to 60 wt. %, preferably 28 to 55 wt. %, more preferably 30 to 50 wt. %, very preferably 35 to 45 wt. %, based in each case on the total weight of the coating composition, or wherein the at least one ethylenically unsaturated monomer (D) is present in a total amount of 60 to 80 wt.-%, in particular of 60 to 65 wt.-%, based in each case on the total weight of the coating composition, or wherein the at least one ethylenically unsaturated monomer (D) is present in a total amount of 15 to 25 wt.-%, based on the total weight of the coating composition.
14. Radiation curable coating composition according to any of the preceding clauses, wherein the at least one ethylenically unsaturated monomer (D) has a calculated Hansen solubility parameter δₚ of at least 5.5 MPa^{1/2}, in particular of 5.6 to 8 MPa^{1/2}.
15. Radiation curable coating composition according to any of the preceding clauses, wherein the ethylenically unsaturated group of the at least one ethylenically unsaturated monomer (D) is selected from (meth)acryloyl groups, in particular from acryloyl groups.
16. Radiation curable coating composition according to any of the preceding clauses, wherein the at least one ethylenically unsaturated monomer (D) is selected from ethylenically unsaturated hydroxy-functional monomers, ethylenically unsaturated alkoxylated monomers, ethylenically unsaturated aliphatic monomers having at least 2 ethylenically unsaturated groups and mixtures thereof, or wherein the at least one ethylenically unsaturated monomer is selected from ethylenically unsaturated alkoxylated monomers, ethylenically unsaturated aliphatic monomers having at least 2 ethylenically unsaturated groups and ethylenically unsaturated cyclic monomers.
17. Radiation curable coating composition according to clause 16, wherein the coating composition comprises a weight ratio of ethylenically unsaturated hydroxy-functional monomers to ethylenically unsaturated alkoxylated monomers to ethylenically unsaturated aliphatic monomers having at least 2 ethylenically unsaturated groups of 2:1:0.4 to 1:2:0.6, preferably of 1:1:0.4 to 1:1:0.7, or wherein the coating composition comprises a weight ratio of ethylenically unsaturated hydroxy-functional monomers to ethylenically unsaturated alkoxylated monomers to ethylenically unsaturated aliphatic monomers having at least 2 ethylenically unsaturated groups of 1:1:4 to 1:1:8 or wherein the coating composition comprises a weight ratio of ethylenically unsaturated alkoxylated monomers to ethylenically unsaturated aliphatic monomers having at least 2 ethylenically unsaturated groups to ethylenically unsaturated cyclic monomers of 4:1:5 to 25:1:15.
18. Radiation curable coating composition according to clause 16 or 17, wherein the ethylenically unsaturated hydroxy-functional monomer is present in the coating composition in a total amount of 5 to 25 wt. %, preferably 10 to 20 wt. %, very preferably 12 to 18 wt. %, based in each case on the total weight of the coating composition.
19. Radiation curable coating composition according to any of clauses 16 to 18, wherein the ethylenically unsaturated hydroxy-functional monomer is selected from 4-hydroxybutyl acrylate.
20. Radiation curable coating composition according to any of clauses 16 to 19, wherein the ethylenically unsaturated alkoxylated monomer is present in the coating composition in a total amount of 5 to 25 wt. %, preferably 10 to 20 wt. %, very preferably 12 to 18 wt. %, based in each case on the total weight of the coating composition.
21. Radiation curable coating composition according to any of clauses 16 to 20, wherein the ethylenically unsaturated alkoxylated monomer is selected from ethylenically unsaturated ethoxylated or propoxylated monomers, preferably ethylenically unsaturated ethoxylated or propoxylated monomers comprising at least two unsaturated groups, in particular from dipropylenglycol diacrylate and/or tripropylene glycol diacrylate.
22. Radiation curable coating composition according to any of clauses 16 to 21, wherein the ethylenically unsaturated aliphatic monomer having at least two ethylenically unsaturated groups is present in the coating composition in a total amount of 1 to 20 wt. %, preferably 2 to 15 wt. %, very preferably 5 to 10 wt. %, based in each case on the total weight of the coating composition, or wherein the ethylenically unsaturated aliphatic monomer having at least two ethylenically unsaturated groups is present in the coating composition in a total amount of 0.1 to 5 wt.-%, preferably of 0.5 to 2.5 wt.-%, based in each case on the total weight of the coating composition or wherein the ethylenically unsaturated aliphatic monomer having at least two ethylenically unsaturated groups is present in the coating composition in a total amount of 20.5 to 35 wt.-%, preferably of 25 to 30 wt.-%, based in each case on the total weight of the coating composition.
23. Radiation curable coating composition according to any of clauses 16 to 22, wherein the ethylenically unsaturated aliphatic monomer having at least 2 ethylenically unsaturated groups is selected from hexandiol diacrylate, trimethylolpropane triacrylate, pentaerythritol triacrylate, pentaerythritol tetracrylate and mixtures thereof.
24. Radiation curable coating composition according to any of the preceding clauses, wherein the at least one photoinitiator (E) is present in a total amount of 1 to 15 wt. %, preferably 2 to 12 wt. %, more preferably 3 to 10 wt. %, very preferably 4 to 7 wt. %, based in each case on the total weight of the coating composition.
25. Radiation curable coating composition according to any of the preceding clauses, wherein the at least one photoinitiator (E) is selected from the group of camphor quinone, benzophenone, benzophenone derivatives, thioxanthones, thioxanthone derivatives, ketal compounds, acetophenone, acetophenone derivatives, 4-aroyl-1,3-dioxolanes, benzoin alkyl ethers and benzil ketals, phenylglyoxalic esters and derivatives thereof, ketosulfones, oximeesters, peresters, monoacyl phosphine oxides, bisacylphosphine oxides, halomethyltriazines, ferrocenium compounds, titanocenes, and mixtures thereof, in particular from a mixture of oxo-phenyl-acetic acid 1-methyl-2-[2-(2-oxo-2-phenyl-acetoxy)-propoxy]-ethyl ester and oxy-phenyl-acetic acid 2-[2-hydroxy-ethoxy]-ethyl ester.
26. Radiation curable coating composition according to any of the preceding clauses, wherein the coating composition comprises 0 wt. %, based on the total weight of the coating composition, of at least one reactive diluent (F) being different from monomers (C) and (D).
27. Radiation curable coating composition according to any one of the preceding clauses, wherein the coating composition further comprises at least one additive (G).
28. Radiation curable coating composition according to clause 27, wherein the at least one additive (G) is selected from pigments, matting agents, adhesion promoters, silicones, light stabilizers such as HALS compounds, benzotriazoles or oxalanilides; rheology modifiers such as sagging control agents (urea crystal modified resins), organic thickeners and inorganic thickeners; free-radical scavengers; slip additives; polymerization inhibitors; defoamers; wetting agents; fluorine compounds; leveling agents; film-forming auxiliaries such as cellulose derivatives; fillers, such as nanoparticles based on silica, alumina or zirconium oxide; flame retardants; and mixtures thereof.
29. Radiation curable coating composition according to any of the preceding clauses, wherein the coating composition contains at least one solvent (H).
30. Radiation curable coating composition according to clause 29, wherein the at least one solvent (H) is selected from aprotic solvents and/or protic solvents.
31. Radiation curable coating composition according to clause 30, wherein the aprotic solvent is selected from aliphatic and/or aromatic hydrocarbons, ketones, esters, amides, methylal, butylal, 1,3-dioxolane, glycerol formal, hydrocarbons and mixtures thereof, preferably from esters, very preferably from ethyl acetate.
32. Radiation curable coating composition according to any of clauses 29 to 31, wherein the at least one solvent (H) is present in a total amount of 5 to 15 wt. %, preferably 8 to 12 wt. %, based in each case on the total weight of the coating composition.
33. Radiation curable coating composition according to any of the preceding clauses, wherein the coating composition consists of components (A), (B), (C), (D) and optionally (E), (G) and (H).
34. Radiation curable coating composition according to any of the preceding clauses, wherein the coating composition is a primer coating composition.
35. Radiation curable coating composition according to any of the preceding clauses, wherein the coating composition has a viscosity of 5 to 15 seconds at 23° C., determined according to DIN EN ISO 2431:2020-02 using a DIN 6 cup.
36. Method for forming a coating onto an object to be coated, said method comprising (iv) applying a radiation curable coating composition according to any one of clauses 1 to 34 to at least part of a surface of the object to be coated, (v) forming a coating film from the coating composition applied in step (i), and (vi) curing the coating film formed in step (ii).
37. Method according to clause 36, wherein the object to be coated is selected from (i) thermoplastics, such as polyolefins, poly(meth)acrylates, polystyrene, polyvinyl chloride (PVC), polyamides, polyurethanes, polycarbonates, polylactic acid (PLA), saturated polyesters like PET (polyethylene terephthalate), ethylene-propylene-diene (EPDM), acrylonitrile-styrene-butadiene (ABS), vinyl polymers selected from halogenated polymers other than PVC, (ii) thermosets, such as phenol resins, epoxy resins, unsaturated poly ester resins, resins with furanic groups, resins with urea groups, melamine resins, poly urethane resins, (iii) mixtures of the aforementioned thermoplastics and thermosets, (iv) fiber-reinforced polymers or composites derived from the above-cited thermoplastics or thermosets, in particular polyamides and polypropylenes.
38. Method according to clause 36 or 37, wherein the step of forming a coating film includes irradiating the coating composition applied in step (i) with a radiation source, in particular with a UV radiation source.
39. Method according to any one of clauses 36 to 38, wherein the step of curing the coating film includes irradiating the coating film formed in step (ii) by means of radiation curing, preferably by means of UV light and/or electron beam curing (EBC), very preferably by means of UV light.
40. The method according to clause 38 or 39, wherein the step of drying is performed at an intensity of 100 to 300 mJ/cm², in particular of 150 to 210 mJ/cm², and wherein the step of curing is performed at an intensity of 100 to 1,000 mJ/cm², in particular of 160 to 210 followed by 750 to 1,000 mJ/cm².
41. Method according to any one of clauses 36 to 40, wherein the film thickness obtained after step (iii) is from 20 to 200 μm, preferably from 20 to 100 μm.
42. Method according to any one of clauses 36 to 41, further comprising (iv) applying at least one further coating composition to the cured coating film formed in step (iii) and curing said applied further coating composition.
43. A coated object obtained by the method of any one of clauses 35 to 42.
44. Use of a radiation curable coating composition of any one of clauses 1 to 35 to improve the surface roughness of plastic substrates, in particular plastic substrates produced by additive manufacturing.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

### 1. Methods of Determination:

### 1.1 Solids Content (Solids, Nonvolatile Fraction)

Unless stated otherwise, the solids content (also called proportion of solids, solid-state content, proportion of nonvolatiles) was determined according to DIN EN ISO 3251: 2018-07 at 130° C.; 60 min, starting weight 1.0 g.

### 1.2 Evaluation of Surface Roughness of Coated Plastic Substrates

The surface roughness of uncoated plastic substrates and plastic substrates coated with a cured primer layer (see point 3.1) was determined using a perthometer (miniprofiler 50, commercially available from Breitmeier Messtechnik GmbH) according to DIN EN ISO 13561-1:1998-04, DIN EN ISO 13561-2:1998-04 and DIN EN ISO 13561-3:2000-08. Each surface roughness result shown further below is the average of 3 individual surface roughness measurements on the respective uncoated and coated substrate.

### 1.3 Temperature Change Test (TCT)

The temperature change test (TCT) of coated substrates was performed as follows: Test duration: 3 cycles, 1 cycle consists of: 95° C. for 15 h, 23±2° C. for 30 min, −40° C. for 8 h and 23±2° C. for 30 min.

The adhesion of the coating layer on the substrate after the TWT test is assessed using the crosshatch test (see point 1.5), the steam jet adhesion test (see point 1.6)) and the degree of blister formation (see point 1.8) 24 to 48 hours after the end of the third cycle.

### 1.4 Constant Climate Test (CCT)

The constant climate test (CCT) for coated substrates was performed according to DIN EN ISO 6270-2:2018-04 (procedure CH) for 240 hours. After the end of the CWT test, the coated substrates are assessed according to DIN EN ISO 4628-2:2016-07 (formation of blisters) and the crosshatch test (see point 1.5).

### 1.5 Crosshatch Test

The crosshatch test was performed on coated substrates before and after the temperature change test and the constant climate test according to DIN EN ISO 2409:2019-09. The results were evaluated according to said DIN norm.

### 1.6 Steam Jet Test

The steam jet test was performed on coated substrates before and after the temperature change test according to DIN EN ISO 16925:2014-06 procedure B. The results were evaluated according to said DIN norm.

### 1.7 Gloss

The gloss of coated substrates was determined according to DIN EN ISO 2813:2015-02 at a measurement geometry of 60°. The obtained gloss values were rated using a grade system of 1 to 5 where grade 1 denotes a high gloss value relative to a reference coating (i.e. a low deviation in gloss units GU from the reference coating) and grade 5 denotes a low gloss value relative to a reference coating (i.e a high deviation in gloss units GU from the reference coating).

### 1.8 Degree of Blister Formation

The degree of blister formation on coated substrates before and after the temperature change test was evaluated according to DIN EN ISO 4628-2:2016-07. The obtained degree of blister formation was either rated according to said DIN EN ISO 4628-2:2016-07 or by using a grade system of 1 to 5, where grade 1 corresponds to the absence of any visible blister formation (i.e. m0g0) and grade 5 corresponds to blisters having a size of 5 (i.e. m2g5 to m5g5).

### 1.9 Flexibility

The flexibility of coated substrates was determined according to DIN EN ISO 1519:2011-04 using an 8 mm mandrel. A grade system of 1 to 5 was used to evaluate the coated substrate after the mandrel bend test has been performed according to DIN EN ISO 1519:2011-04. Grade 1 corresponds to a coated substrate showing no visible cracks or delamination of the coating layer from the substrate (i.e. having a high flexibility), while grade 5 corresponds to a coated substrate showing a large amount of cracks and/or a high degree of delamination from the substrate (i.e. having a low flexibility).

### 2 Preparation of Primer Coating Compositions

The primer coating compositions of Tables 1 and 2 were obtained by mixing the ingredients listed in said tables.

TABLE 1
Ingredients for different inventive and comparative primer coating
compositions (all amounts are given in wt. %, based on the total
weight of the respective primer coating composition)

| | PR1* | PR2-1* | PR3 | PR2-2* | PR2-3* |
|---|---|---|---|---|---|
| Ebecryl 5129 ¹⁾ | 12.9 | 14.6 | 36.0 | 14.6 | — |
| Ebecryl 767 ²⁾ | 22.4 | 25.1 | — | 25.1 | 10.0 |
| Laromer 9047 ³⁾ | — | — | — | — | 10.0 |
| Ebecryl 524 ⁴⁾ | — | — | — | — | 7.60 |
| Ebecryl 780 ⁵⁾ | — | — | — | — | 7.60 |
| Laromer DPGDA ⁶⁾ | 14.9 | 16.5 | 16.5 | 16.5 | 17.0 |
| Butandiol monoacrylate ⁷⁾ | 14.9 | 16.5 | 16.5 | 16.5 | 17.0 |
| Isobornyl acrylate ⁸⁾ | 14.9 | 16.5 | 16.5 | — | — |
| Hexandiol diacrylate ⁹⁾ | 4.40 | 5.00 | 8.70 | 5.00 | 5.00 |
| Omnirad 754 1⁰⁾ | 5.20 | 5.80 | 5.80 | 5.80 | 5.80 |
| Ethyl acetate | 10.4 | — | — | — | — |
| Sum (calculated HSP δₚ) < | 23.4 | 26.0 | 26.0 | 9.5 | 3.8 |
| 5 MPa^{1/2} [wt. %] ¹¹⁾ | | | | | |
| Sum (calculated HSP δₚ) > | 39.8 | 44.3 | 56.1 | 60.8 | 61.5 |
| 5 MPa^{1/2} [wt. %] ¹²⁾ | | | | | |

*inventive
¹⁾ hexafunctional aliphatic urethane acrylate oligomer (60 wt. % in 40 wt. % of a mixture of pentaerythritol triacrylate and pentaerythritol tetracrylate; supplied by Allnex GmbH),
²⁾ acid functionalized acrylic resin diluted with 38 wt. % of isobornyl acrylate monomer and 2 wt. % of trimethylolpropane triacrylate (supplied by Allnex GmbH),
³⁾ aliphatic urethane acrylate (70 wt. % in 30 wt. % butyl acetate; supplied by BASF Corporation),
⁴⁾ acid-modified polyester acrylate oligomer (70 wt. % in 30 wt. % 1,6-hexanediol diacrylate; supplied by Allnex GmbH),
⁵⁾ carboxylic acid containing methacrylate oligomer (70 wt. % in 30 wt. % 2-methoxy-1-propanol; supplied by Allnex GmbH),
⁶⁾ dipropylenglycol diacrylate, calculated Hansen solubility parameter δₚ = 6.2 MPa^{1/2} (supplied by BASF SE),
⁷⁾ calculated Hansen solubility parameter δp = 7.5 MPa^{1/2},
⁸⁾ calculated Hansen solubility parameter δp = 4.2 MPa^{1/2},
⁹⁾ calculated Hansen solubility parameter δp = 5.9 MPa^{1/2},
¹⁰⁾ blend of oxy-phenyl-acetic acid 2-[2-oxo-2-phenyl-acetoxy-ethoxy]-ethyl ester and oxy-phenyl-acetic acid 2-[2-hydroxy-ethoxy]-ethyl ester (supplied by IGM Resins),
¹¹⁾ total amount of monomers in respective primer coating composition (in wt.-%, based on total weight of respective primer coating composition) having a calculated Hansen solubility parameter δₚ of less than 5 MPa^{1/2},
¹²⁾ total amount of monomers in respective primer coating composition (in wt.-%, based on total weight of respective primer coating composition) having a calculated Hansen solubility parameter δₚ of at least 5 MPa^{1/2}.

The inventive primer coating composition PR1 comprises 23.4 wt. % of an unsaturated monomer having a calculated Hansen solubility parameter δₚ of less than 5 MPa^{1/2} (isobornyl acrylate with a δₚ of 4.2 MPa^{1/2}) and 39.8 wt. % of unsaturated monomers having a calculated Hansen parameter solubility parameter δₚ of more than 5 MPa^{1/2} (pentaerythritol triacrylate with a δₚ of 7.7 MPa^{1/2}, pentaerythritol tetracrylate with a 8p of 6.9 MPa^{1/2}, trimethylolpropane triacrylate with a δₚ of 6.3 MPa^{1/2}, dipropylenglycol diacrylate with a δₚ of 6.2 MPa^{1/2}, butandiol monoacrylate with a δₚ=7.5 MPa^{1/2}, hexandiol diacrylate with a δₚ=5.9 MPa^{1/2}). The inventive primer coating composition PR1 comprises a solid content of at least 74 wt. % and has a viscosity of 10 seconds at 23° C. (determined according to DIN EN ISO 2431:2020-02 using a DIN 6 cup). The total amount of monomers having a calculated Hansen solubility parameter δₚ of less than 5 MPa^{1/2} as well as the total amount of monomers having a calculated Hansen solubility parameter δₚ of at least than 5 MPa^{1/2} was determined by considering all monomers present within the respective primer coating composition, including monomers used to dilute the oligomers/resins.

TABLE 2
Ingredients for different inventive and comparative flexible primer
coating compositions (all amounts are given in wt. %, based on
the total weight of the respective primer coating composition)

| | PR4* | PR5 | PR6* | PR7 | PR8* | PR9 |
|---|---|---|---|---|---|---|
| Ebecryl 767 ¹⁾ | 10 | — | 13 | — | 10 | — |
| Laromer UA19T ²⁾ | 10 | 20 | 10 | 23 | 10 | 20 |
| Ebecryl 244 ³⁾ | 10 | 10 | 10 | 10 | — | — |
| Laromer 9033 ⁴⁾ | 40 | 40 | 47 | 47 | 55 | 55 |
| Laromer DPGDA ⁵⁾ | 5 | 5 | 15 | 15 | 20 | 20 |
| Isobornyl acrylate ⁶⁾ | 20 | 20 | — | — | — | — |
| Omnirad 754 ⁷⁾ | 5.0 | 5.0 | 5.0 | 5.0 | 5.0 | 5.0 |
| Sum (calculated HSP δₚ) <5 | 24 | 20 | 4.9 | 0 | 3.8 | 0 |
| MPa^{1/2} [wt. % ] ⁸⁾ | | | | | | |
| Sum (calculated HSP δₚ) >5 | 21 | 24 | 33 | 37 | 39 | 42 |
| MPa^{1/2} [wt. %] ⁹⁾ | | | | | | |

*inventive
¹⁾ acid functionalized acrylic resin diluted with 38 wt. % of isobornyl acrylate monomer and 2 wt. % of trimethylolpropane triacrylate (supplied by Allnex GmbH),
²⁾ 65 wt. % aliphatic urethane-modified acrylate oligomer diluted with 35 wt. % tripropyleneglycol diacrylate (supplied by BASF Corporation),
³⁾ 90 wt. % aliphatic urethane diacrylate oligomer diluted with 10 wt. % of 1,6-hexanediol diacrylate (supplied by Allnex GmbH),
⁴⁾ 70 wt. % aliphatic urethane-modified acrylic resin diluted with 30 wt. % Laromer LR 8887 (supplied by BASF Corporation),
⁵⁾ dipropylenglycol diacrylate, calculated Hansen solubility parameter δₚ = 6.2 MPa^{1/2} (supplied by BASF SE),
⁶⁾ calculated Hansen solubility parameter δₚ = 4.2 MPa^{1/2},
⁷⁾ blend of oxy-phenyl-acetic acid 2-[2-oxo-2-phenyl-acetoxy-ethoxy]-ethyl ester and oxy-phenyl-acetic acid 2-[2-hydroxy-ethoxy]-ethyl ester (supplied by IGM Resins),
⁸⁾ total amount of monomers in respective primer coating composition (in wt.-%, based on total weight of respective primer coating composition) having a calculated Hansen solubility parameter δₚ of less than 5 MPa^{1/2},
⁹⁾ total amount of monomers in respective primer coating composition (in wt.-%, based on total weight of respective primer coating composition) having a calculated Hansen solubility parameter δₚ of at least 5 MPa^{1/2}.

The total amount of monomers having a calculated Hansen solubility parameter δₚ of less than 5 MPa^{1/2} as well as the total amount of monomers having a calculated Hansen solubility parameter δₚ of at least than 5 MPa^{1/2} was determined by considering all monomers present within the respective primer coating composition, including monomers used to dilute the oligomers/resins.

### 3. Preparation of Coated Substrates

The following plastic substrates were used:

Polyamide 6 (PA 6), polyamide 11 (PA 11), polyamide 12 (PA 12), polypropylene with a round shape (PP round), polypropylene with an angular shape (PP angular), thermoplastic polyurethane substrates (TPU), polypropylene substrates produced by multi jet fusion printing (PP MJF), polypropylene substrates produced by selective laser sintering (PP SLS) and polypropylene substrates purchased from HP (PP HP). All plastic substrates were fabricated using additive manufacturing processes, such as 3D printing processes.

The plastic substrates were cleaned with isopropanol using a microfiber cloth prior to applying the primer layer as described in point 3.1.

### 3.1 Substrates Comprising a Cured Primer Layer

Substrates comprising a cured primer layer in a dry film thickness of 25 μm were prepared as follows:

The cleaned plastic substrates were treated with compressed air and each primer coating composition prepared according to point 2 was applied to both sides of the respective plastic substrate by pneumatic spray application at 23° C. and 63% relative humidity using a pressure of 1.3 bar (spray gun: SATA minjet 4400B RP Digital, nozzle size: 0.8-1 mm) such that the resulting dry film thickness is 25 μm. Afterwards, the applied coating layer was dried using a UV light source (commercially available mercury lamp having UVA, UVB und UVC light sources) at an intensity of 170 to 190 mJ/cm² (measured with UV radiometer IL390 or IL490-UVA) and cured with the UV light source at an intensity of 170 to 190 mJ/cm² followed by an intensity of 800 to 950 mJ/cm².

Substrates comprising a cured primer layer in a dry film thickness of 80 μm were prepared as previously described with the following deviations: the dry film thickness of each applied primer coating layer is 20 μm and the primer coating composition is applied 4 times with the previously described drying interval between each application. After the last primer coating layer is applied and dried, curing is performed at an intensity of 800 to 950 mJ/cm².

### 3.2 Substrates Comprising a Multilayer Coating

### 3.2.1 Substrates Comprising Multilayer Coating MC1

Firstly, a cured primer coating layer was prepared on substrates PA 6, PA 11, PA 12 and polypropylene (round and angular shape) as described in point 3.1. Afterwards, a commercially available light grey primer-surfacer (Glasurit 801-705 CV-HS primer-surfacer EP light grey, BASF Coatings GmbH) was applied on each substrate pneumatically in two spraying passes such that the film thickness of the resulting primer-surfacer layer after curing was 20 to 40 μm. The applied primer-surfacer layer was cured at an oven temperature of 60° C. for 30 minutes before a commercially available black water-borne basecoat (Ultracur3D Coat F, BASF Coatings GmbH) was applied on each substrate pneumatically at 23° C. and 63% relative humidity using a pressure of 1.5 bar (spray gun: SATA jet 4000B RP Digital, nozzle size: 1.3 mm) in four spraying passes such that the resulting dry film thickness is around 25 μm. The applied basecoat is dried at 23° C. for 5 minutes and then cured at an oven temperature of 80° C. for 15 minutes.

### 3.2.2 Substrates Comprising Multilayer Coating MC2

Firstly, a cured primer coating layer was prepared on substrates PA 6, PA 11, PA 12, polypropylene (round and angular shape), PP SLS, PP MJF and PP HP as described in point 3.1. Afterwards, a commercially available light grey primer-surfacer (Glasurit 801-705 CV-HS primer-surfacer EP light grey, BASF Coatings GmbH) was applied on each substrate pneumatically in two spraying passes such that the film thickness of the resulting primer-surfacer layer after curing was 20 to 40 μm. The applied primer-surfacer layer was cured at an oven temperature of 60° C. for 30 minutes before a commercially available topcoat (Glasurit HS-2K-CV topcoat) was applied on each substrate pneumatically such that the film thickness of the resulting topcoat layer after curing was 40 to 60 μm. After curing the formed topcoat layer at 60° C. for 30 minutes, the respective plastic substrate comprising multilayer coating MC2 was obtained.

### 3.2.3 Substrates Comprising Multilayer Coating MC3

Firstly, a cured primer coating layer was prepared on substrates PA6, PA 11 and PA 12, PP SLS and PP HP as described in point 3.1. Afterwards, a commercially available topcoat (Glasurit HS-2K-CV topcoat) was applied on each substrate pneumatically such that the film thickness of the resulting topcoat layer after curing was 40 to 60 μm. After curing the formed topcoat layer at 60° C. for 30 minutes, the respective plastic substrate comprising multilayer coating MC3 was obtained.

### 3.2.4 Substrates Comprising Multilayer Coating MC4

Firstly, a cured primer coating layer was prepared on the TPU substrate as described in point 3.1. Afterwards, a commercially available light grey primer-surfacer (Glasurit 801-705 CV-HS primer-surfacer EP light grey, BASF Coatings GmbH) was applied on each substrate pneumatically in two spraying passes such that the film thickness of the resulting primer-surfacer layer after curing was 20 to 40 μm. The applied primer-surfacer layer was cured at an oven temperature of 60° C. for 30 minutes before a commercially available blue water-borne basecoat (Ultracur3D Coat F, BASF Coatings GmbH) was applied on each substrate pneumatically at 23° C. and 63% relative humidity using a pressure of 1.5 bar (spray gun: SATA jet 4000B RP Digital, nozzle size: 1.3 mm) in four spraying passes such that the resulting dry film thickness is around 25 μm. The applied basecoat is dried at 23° C. for 5 minutes and then cured at an oven temperature of 80° C. for 15 minutes.

### 3.2.5 Substrates Comprising Multilayer Coating MC5

Firstly, a cured primer coating layer was prepared on the TPU substrate as described in point 3.1. Afterwards, a commercially available light grey primer-surfacer (Glasurit 801-705 CV-HS primer-surfacer EP light grey, BASF Coatings GmbH) was applied on each substrate pneumatically in two spraying passes such that the film thickness of the resulting primer-surfacer layer after curing was 20 to 40 μm. The applied primer-surfacer layer was cured at an oven temperature of 60° C. for 30 minutes before a commercially available topcoat (Glasurit HS-2K-CV topcoat with 30 wt.-% Softface 522-111 available from BASF Coatings GmbH) was applied on each substrate pneumatically such that the film thickness of the resulting topcoat layer after curing was 40 to 60 μm. After curing the formed topcoat layer at 60° C. for 30 minutes, the respective plastic substrate comprising multilayer coating MC2 was obtained.

### 4. Results

### 4.1 Results of Surface Roughness Measurements

The results of the surface roughness of uncoated substrates and substrates coated with a cured primer layer (prepared according to point 3.1) are given in Tables 1 and 2.

TABLE 1
Result of surface roughness measurements of uncoated
substrates and substrates coated with a cured primer
layer having a dry film thickness of 25 μm

| | Uncoated substrate | | | Coated substrate | | |
|---|---|---|---|---|---|---|
| | Rₐ | R_{z} | Rₘₐₓ | Rₐ | R_{z} | Rₘₐₓ |
| PA 11 | 8.326 | 55.647 | 62.893 | 0.814 | 4.474 | 5.187 |
| PA 12 | 11.472 | 70.744 | 93.697 | 1.396 | 6.489 | 10.724 |
| PP round | 12.323 | 87.374 | 107.133 | 1.037 | 4.867 | 6.141 |
| PP angular | 12.548 | 88.997 | 106.756 | 1.03 | 5.946 | 8.165 |

TABLE 2
Result of surface roughness measurements of uncoated
substrates and substrates coated with a cured primer
layer having a dry film thickness of 80 μm

| | |
|---|---|
| Uncoated substrate | Coated substrate |

| | Rₐ | R_{z} | Rₘₐₓ | Rₐ | R_{z} | Rₘₐₓ |
|---|---|---|---|---|---|---|
| PA 11 | 15 | 81.26 | 98.34 | 0.06 | 0.35 | 0.46 |
| PA 12 | 6.49 | 39.84 | 48.96 | 0.08 | 0.37 | 0.58 |
| PP round | 11.46 | 70.19 | 86.85 | 0.16 | 0.57 | 1.36 |
| PP angular | 10.16 | 63.31 | 74.1 | 0.13 | 1.14 | 2.99 |

### 4.2 Results of Temperature Change Test (TCT)

The results of the temperature change test (TCT) for different substrates comprising multilayer coating MC1 or MC2 are given in Tables 3 and 4.

TABLE 3
Results of temperature change test (TCT) on different
substrates coated with multilayer coating MC1

| | | Substrate | | | |
|---|---|---|---|---|---|
| | | | | | PP |
| | | PA 6 | PA 11 | PA 12 | angular |
| Before TCT | Crosshatch (1.5 mm) | 2, 5 | 3, 5 | 2, 5 | 5 |
| | Crosshatch (2.0 mm) | 3 | 3 | 4 | 3 |
| | Steam jet test | 1a | 3b | 3b | 2b |
| After TCT | Crosshatch (2.0 mm) | 2 | 1 | 1 | 2 |
| | Steam jet test | 1a | 0 | 0 | 4a |

TABLE 4
Results of temperature change test (TCT) on different
substrates coated with multilayer coating MC2

| | | Substrate | | | |
|---|---|---|---|---|---|
| | | | | | PP |
| | | PA 6 | PA 11 | PA 12 | angular |
| Before TCT | Crosshatch (1.5 mm) | 2 | 2 | 2 | 1, 5 |
| | Crosshatch (2.0 mm) | 2 | 1 | 3 | 2 |
| | Steam jet test | 0 | 0 | 3b | 3b |
| After TCT | Crosshatch (2.0 mm) | 0 | 0 | 0 | 0 |
| | Steam jet test | 1 | 1 | 0 | 0 |

### 4.3 Results of Constant Climate Test (CCT)

The results of the constant climate test (CCT) for different substrates comprising a multilayer coating MC2 are given in Table 5.

TABLE 5
Results of constant climate test (CCT) of coated
substrates comprising multilayer coating MC2

| | | Substrate | | | |
|---|---|---|---|---|---|
| | | PA 6 | PA 11 | PA 12 | PP |
| Before CCT | Crosshatch (1.5 mm) | 2 | 2 | 2 | 1, 5 |
| | Crosshatch (2.0 mm) | 2 | 1 | 3 | 2 |
| After CCT | Crosshatch (1.5 mm) | 1, 5 | 1 | 1, 5 | 1 |
| | Crosshatch (2.0 mm) | 1 | 1 | 1 | 1 |
| | Blisters ¹⁾ | m0g0 | m2g4 | m4g2 | m0g0 |

¹⁾ m = amount, g = size

### 4.4 Visual Impression of Substrates Comprising a Cured Primer Layer and Substrates Comprising Multilayer Coatings MC1 and MC2

Application and curing of the primer coating composition PR1 does not result in undesired film defects, such as blisters or craters. Without wishing to be bound to this theory, the absence of film defects in the primer layer is due to the fact that the solvent and any gases formed during curing can fully evaporate during the curing process, thus resulting in a cured coating layer having a high optical quality.

Plastic substrates comprising the multilayer coating MC1 or MC2 exhibit a high optical quality without the occurrence of any film defects in any of the cured coating layers.

### 4.5 Comparison of Substrates Comprising Multilayer Coatings Prepared Using Inventive Primer Composition PR2-1 and Comparative Primer Composition PR3

Multilayer coating MC2 was prepared using inventive primer coating composition PR2-1 as well as comparative primer coating composition PR3 on PA11 and PA12 substrates as described in point 3.2.2. Multilayer coating MC3 was prepared using inventive primer coating composition PR2-1 as well as comparative primer coating composition PR3 on PA11 and PA12 substrates as described in point 3.2.3. The steam jet adhesion, gloss as well as the degree of blistering before and after the temperature change test (TCT) was evaluated as described above. The obtained results are listed in Tables 6 and 7.

TABLE 6
Results for multilayer coating MC2 prepared using
inventive primer coating composition PR2-1 and
comparative primer coating composition PR3

| Substrate | Test method | MC2 with PR2-1* | MC2 with PR3 |
|---|---|---|---|
| PA11 | Steam jet test | 1 | 4 |
| | Gloss | 2 | 3 |
| | Blisters before TCT | 1 | 1 |
| | Blisters after TCT | 1 | 1 |
| PA12 | Steam jet test | 1 | 4 |
| | Gloss | 2 | 2 |
| | Blisters before TCT | 1 | 1 |
| | Blisters after TCT | 1 | 1 |

*inventive

TABLE 7
Results for multilayer coating MC3 prepared using
inventive primer coating composition PR2-1 and
comparative primer coating composition PR3

| Substrate | Test method | MC3 with PR2-1* | MC3 with PR3 |
|---|---|---|---|
| PA11 | Steam jet test | 1 | 4 |
| | Gloss | 2 | 3 |
| | Blisters before TCT | 1 | 1 |
| | Blisters after TCT | 1 | 1 |
| PA12 | Steam jet test | 1 | 4 |
| | Gloss | 2 | 2 |
| | Blisters before TCT | 1 | 1 |
| | Blisters after TCT | 1 | 1 |

*inventive

The comparative multilayers MC2 and MC3 having been prepared using primer coating composition PR3 not comprising an acid-functionalized acrylic resin show reduced adhesion in the steam jet test as well as lower gloss/leveling. The absence of the acid-functionalized acrylic resin results in a lower interlayer adhesion between the primer coating layer and the primer-surfacer layer (MC2) or the topcoat layer (MC3) such that delamination of the primer-surfacer layer or topcoat layer is observed for comparative multilayer coatings MC2 and MC3 during the steam jet test. Moreover, the absence of the acid-functionalized acrylic resin also results in a lower adhesion of the primer layer to the substrate, such that—apart from the delamination of the primer-surfacer layer or topcoat layer—also a delamination of the primer layer from the substrate is observed for comparative multilayer coatings MC2 and MC3.

### 4.6 Comparison of Substrates Comprising Multilayer Coatings Prepared Using Inventive Primer Compositions PR2-2 and PR2-3

Multilayer coating MC2 was prepared using inventive primer coating compositions PR2-2 and PR2-3, respectively, on PA6, PA11 and PA12, PP MJF and PP SLS substrates as described in point 3.2.2. Multilayer coating MC3 was prepared using inventive primer coating compositions PR2-2 and PR2-3, respectively, on PA11 and PA12, PP SLS and PP HP substrates as described in point 3.2.3. The steam jet adhesion, gloss as well as the degree of blistering before and after the temperature change test (TCT) was evaluated as described above. The obtained results are listed in Tables 8 to 11.

TABLE 8
Results for multilayer coating MC2 prepared using
inventive primer coating composition PR2-2

| Substrate | Test method | Result |
|---|---|---|
| PA11 | Steam jet test | 1 |
| | Gloss | 1 |
| | Blisters before TCT | 1 |
| | Blisters after TCT | 1 |
| PA12 | Steam jet test | 1 |
| | Gloss | 1 |
| | Blisters before TCT | 1 |
| | Blisters after TCT | 1 |
| PA 6 | Steam jet test | 2 |
| | Gloss | 2 |
| | Blisters before TCT | 1 |
| | Blisters after TCT | 1 |
| PP MJF | Steam jet test | 1 |
| | Gloss | 1 |
| | Blisters before TCT | 1 |
| | Blisters after TCT | 1 |
| PP SLS | Steam jet test | 1 |
| | Gloss | 1 |
| | Blisters before TCT | 1 |
| | Blisters after TCT | 1 |

TABLE 9
Results for multilayer coating MC2 prepared using
inventive primer coating composition PR2-3

| Substrate | Test method | Result |
|---|---|---|
| PA11 | Steam jet test | 2 |
| | Gloss | 1 |
| | Blisters before TCT | 1 |
| | Blisters after TCT | 1 |
| PA12 | Steam jet test | 2 |
| | Gloss | 1 |
| | Blisters before TCT | 1 |
| | Blisters after TCT | 1 |
| PA 6 | Steam jet test | 2 |
| | Gloss | 2 |
| | Blisters before TCT | 1 |
| | Blisters after TCT | 1 |
| PP SLS | Steam jet test | 2 |
| | Gloss | 2 |
| | Blisters before TCT | 1 |
| | Blisters after TCT | 1 |

TABLE 10
Results for multilayer coating MC3 prepared using
inventive primer coating composition PR2-2

| Substrate | Test method | Result |
|---|---|---|
| PA11 | Steam jet test | 1 |
| | Gloss | 1 |
| | Blisters before TCT | 1 |
| | Blisters after TCT | 1 |
| PA12 | Steam jet test | 1 |
| | Gloss | 2 |
| | Blisters before TCT | 1 |
| | Blisters after TCT | 1 |
| PP SLS | Steam jet test | 1 |
| | Gloss | 1 |
| | Blisters before TCT | 1 |
| | Blisters after TCT | 1 |
| PP HP | Steam jet test | 1 |
| | Gloss | 2 |
| | Blisters before TCT | 1 |
| | Blisters after TCT | 1 |

TABLE 11
Results for multilayer coating MC3 prepared using
inventive primer coating composition PR2-3

| Substrate | Test method | Result |
|---|---|---|
| PA11 | Steam jet test | 2 |
| | Gloss | 1 |
| | Blisters before TCT | 1 |
| | Blisters after TCT | 1 |
| PA12 | Steam jet test | 1 |
| | Gloss | 3 |
| | Blisters before TCT | 1 |
| | Blisters after TCT | 1 |
| PP SLS | Steam jet test | 2 |
| | Gloss | 2 |
| | Blisters before TCT | 1 |
| | Blisters after TCT | 1 |
| PP HP | Steam jet test | 3 |
| | Gloss | 2 |
| | Blisters before TCT | 1 |
| | Blisters after TCT | 1 |

The multilayer coatings MC2 and MC3 each being prepared using inventive primer coating compositions PR2-2 and PR2-3, respectively, show a high degree of gloss as well as a high wet adhesion to the substrate as well as a high interlayer adhesion within the multilayer coating. Moreover, the multilayer coatings have a high optical quality because formation of blisters after the coating procedures is not observed for any multilayer coating. Moreover, the inventive primer compositions show a high adhesion on a wide variety of substrates, thus allowing to use the inventive primer coating compositions universally.

### 4.7 Comparison of Substrates Comprising Inventive Flexible Primer Coating Layers and Comparative Flexible Primer Coating Layers

Coated substrates were prepared using inventive flexible primer coating compositions PR4, PR6, PR8 as well as comparative flexible primer coating compositions PR5, PR7, PR9 as described in point 3.1 using TPU substrates. The flexibility as well as the degree of blistering of the coated substrates was evaluated as described above. The obtained results are listed in Table 12.

TABLE 12
Results for coated substrates using inventive flexible
primer coating compositions PR4, PR6, PR8 and comparative
flexible primer coating compositions PR5, PR7, PR9

| | TPU | TPU | TPU | TPU | TPU | TPU |
|---|---|---|---|---|---|---|
| | with | with | with | with | with | with |
| | PR4* | PR5 | PR6* | PR7 | PR8* | PR9 |
| Flexibility | 1 | 3 | 1 | 3 | 1 | 3 |
| Blisters before TCT | 1 | 3 | 1 | 3 | 2 | 3 |

*inventive

The comparative coated substrates having been prepared using comparative flexible primer coating compositions PR5, PR7 and PR9 not comprising an acid-functionalized acrylic resin (PR7) or not comprising the acid-functionalized acrylic resin and at least one monomer having an HSP of δₚ)<5 MPa^{1/2} show reduced flexibility as well as increased blistering, thus resulting in coated substrates having a decreased optical quality.

### 4.8 Comparison of Substrates Comprising Multilayer Coatings Prepared Using Inventive Flexible Primer Compositions PR4, PR6, PR8 and Comparative Flexible Primer Compositions PR5, PR7, PR9

Multilayer coating MC4 was prepared using inventive flexible primer coating compositions PR4, PR6, PR8 as well as comparative flexible primer coating compositions PR5, PR7, PR9 as described in point 3.2.4. Multilayer coating MC5 was prepared using inventive flexible primer coating compositions PR4, PR6, PR8 as well as comparative flexible primer coating compositions PR5, PR7, PR9 as described in point 3.2.5. The steam jet adhesion was evaluated as described above. The obtained results are listed in Table 13.

TABLE 13
Results for multilayer coatings MC4 and MC5 prepared using inventive
flexible primer coating compositions PR4, PR6, PR8 and comparative
flexible primer coating compositions PR5, PR7, PR9

| Multilayer coating | Steam jet test result |
|---|---|
| MC4 with PR4* | OK |
| MC4 with PR5 | Not OK (35% delamination) |
| MC4 with PR6* | OK |
| MC4 with PR7 | Not OK (45% delamination) |
| MC4 with PR8* | OK |
| MC4 with PR9 | Not OK (50% delamination) |
| MC5 with PR4* | OK |
| MC5 with PR5 | Not OK (30% delamination) |
| MC5 with PR6* | OK |
| MC5 with PR7 | Not OK (35% delamination) |
| MC5 with PR8* | OK |
| MC5 with PR9 | Not OK (50% delamination) |

*inventive

The comparative multilayers MC4 and MC5 having been prepared using comparative flexible primer coating compositions PR5, PR7 and PR9 not comprising an acid-functionalized acrylic resin (PR7) or not comprising the acid-functional acrylic resin as well as the at least one monomer having an HSP of δₚ)<5 MPa^{1/2} show reduced adhesion in the steam jet test. The absence of the acid-functionalized acrylic resin results in a lower interlayer adhesion between the primer coating layer and the primer-surfacer layer such that delamination of the primer-surfacer layer is observed for comparative multilayer coatings MC4 and MC5 during the steam jet test. Moreover, the absence of the acid-functionalized acrylic resin also results in a lower adhesion of the primer layer to the substrate, such that—apart from the delamination of the primer-surfacer layer or topcoat layer—also a delamination of the primer layer from the substrate is observed for comparative multilayer coatings MC4 and MC5.

### 5. Discussion of the Results

Use of the inventive coating composition as primer layer on various plastic substrates results in a significantly reduced surface roughness of the coated plastic substrates. This significant reduction in surface roughness renders the inventive coating compositions especially suitable for use in combination with plastic materials prepared according to AM processes, because these plastic materials have a high surface roughness which is undesired for most applications. The significant reduction in surface roughness is achieved without sanding or blasting the plastic surface prior to application of the primer coating composition, therefore rendering a cost and time intensive surface preparation superfluous. Moreover, the primer coating layer can be easily overcoated with pigmented coating compositions and provides improved adhesion, especially under wet conditions, without any further process steps, such as sanding, prior to application of the further coating layer. Finally, the cured primer layer does not negatively influence the high optical quality of multilayer coatings comprising said primer layer.

In conclusion, use of coating compositions of the invention results in a significant reduction of the surface roughness of plastic substrates and improved wet adhesion of multilayer coatings comprising a primer coating layer produced form the inventive coating compositions without a negative influence on the optical quality of the coated substrates.

1. A radiation curable coating composition-based on the total weight of the coating composition—
a) at least one unsaturated urethane (meth)acrylate oligomer or polymer (A),
b) at least one unsaturated acid-functional acrylic (meth)acrylate oligomer or polymer (B),
c) at least one ethylenically unsaturated monomer (C) having a calculated Hansen solubility parameter δₚ of less than 5 MPa^{1/2},
d) more than 20 wt. % of at least one ethylenically unsaturated monomer (D) having a calculated Hansen solubility parameter δₚ of at least 5 MPa^{1/2}, and
e) optionally at least one photoinitiator (E),
wherein the solubility parameter δₚ is calculated according to the method described in “Pencil and Paper Estimation of Hansen Solubility Parameters” by Didier Mathieu, ACS Omega, 2018, Vol. 3, pages 17049 to 17056.

2. The radiation curable coating composition according to claim 1, wherein the at least one ethylenically unsaturated monomer (C) is present in a total amount of 0.1 to 35 wt. % based on the total weight of the coating composition.

3. The radiation curable coating composition according to claim 1, wherein the at least one ethylenically unsaturated monomer (C) has a calculated Hansen solubility parameter δₚ of less than 4.5 MPa^{1/2}.

4. The radiation curable coating composition according to claim 1, wherein the at least one ethylenically unsaturated monomer (C) is selected from the group consisting of ethylenically unsaturated cycloaliphatic monomers and ethylenically unsaturated aliphatic monomers.

5. The radiation curable coating composition according to claim 1, wherein the at least one ethylenically unsaturated monomer (C) is isobornyl (meth)acrylate.

6. The radiation curable coating composition according to claim 1, wherein the at least one ethylenically unsaturated monomer (D) is present in a total amount of 25 to 60 wt. % based on the total weight of the coating composition.

7. The radiation curable coating composition according to claim 1, wherein the at least one ethylenically unsaturated monomer (D) has a calculated Hansen solubility parameter δₚ of at least 5.5 MPa^{1/2}.

8. The radiation curable coating composition according to claim 1, wherein the at least one ethylenically unsaturated monomer (D) is selected from the group consisting of ethylenically unsaturated hydroxy-functional monomers, ethylenically unsaturated alkoxylated monomers, ethylenically unsaturated aliphatic monomers having at least 2 ethylenically unsaturated groups and mixtures thereof.

9. The radiation curable coating composition according to claim 8, wherein the coating composition comprises a weight ratio of ethylenically unsaturated hydroxy-functional monomers to ethylenically unsaturated alkoxylated monomers to ethylenically unsaturated aliphatic monomers having at least 2 ethylenically unsaturated groups of 2:1:0.4 to 1:2:0.6.

10. The radiation curable coating composition according to claim 1, wherein the at least one photoinitiator (E) is present in a total amount of 1 to 15 wt. % based on the total weight of the coating composition.

11. The radiation curable coating composition according to claim 1, wherein the coating composition is a primer coating composition.

12. A method for forming a coating onto an object to be coated, said method comprising
(i) applying a radiation curable coating composition according to claim 1 to at least part of a surface of the object to be coated,
(ii) forming a coating film from the coating composition applied in step (i), and
(iii) curing the coating film formed in step (ii).

13. A coated object obtained by the method of claim 12.

14. A method of using the radiation curable coating composition of claim 1, the method comprising using the radiation curable coating composition to improve the surface roughness of plastic substrates.

15. The radiation curable coating composition according to claim 1, wherein the at least one ethylenically unsaturated monomer (C) is present in a total amount of 5 to 40 wt. %.

16. The radiation curable coating composition according to claim 1, wherein the at least one ethylenically unsaturated monomer (C) has a calculated Hansen solubility parameter δₚ of 1 to 4.5 MPa^{1/2}.

17. The radiation curable coating composition according to claim 1, wherein the at least one ethylenically unsaturated monomer (C) is isobornyl acrylate.

18. The radiation curable coating composition according to claim 1, wherein the at least one ethylenically unsaturated monomer (D) is present in a total amount of 28 to 55 wt. %.

19. The radiation curable coating composition according to claim 1, wherein the at least one ethylenically unsaturated monomer (D) has a calculated Hansen solubility parameter δₚ of 5.6 to 8 MPa^{1/2}.

20. The radiation curable coating composition according to claim 8, wherein the coating composition comprises a weight ratio of ethylenically unsaturated hydroxy-functional monomers to ethylenically unsaturated alkoxylated monomers to ethylenically unsaturated aliphatic monomers having at least 2 ethylenically unsaturated groups of 1:1:0.4 to 1:1:0.7.
